(19) United States
(12) Patent Application Publication
(10) Pub. No.: US 2025/0189118 A1
(43) Pub. Date: Jun. 12, 2025

(54) Systems, Methods, and Apparatuses for Producing High-Pressure Steam

(71) Applicant: SKYVEN TECHNOLOGIES, Richardson, TX (US)

(72) Inventor: Arun Kumar GUPTA, Oakland, CA (US)

(21) Appl. No.: 19/054,613

(22) Filed: Feb. 14, 2025

Related U.S. Application Data
(63) Continuation-in-part of application No. PCT/US2023/030626, filed on Aug. 18, 2023.
(60) Provisional application No. 63/371,837, filed on Aug. 18, 2022.

(51) Int. Cl. F22B 3/04; C02F 1/06

(52) U.S. Cl. CPC F22B 3/04; C02F 1/06

(57) ABSTRACT

Systems, methods, and apparatuses for producing high-pressure steam are provided. A compressor train includes a series of at least two compressors, an inlet of the compressor train, and an outlet of the compressor train. The outlet of the compressor train is configured to provide high-pressure steam to a facility. A flash vessel train includes a series of at least two flash vessels. The series of at least two flash vessels includes a terminal flash vessel at one end of the flash vessel train. Furthermore, a vapor outlet of the terminal flash vessel is fluidly coupled to the inlet of the compressor train. Additionally, vapor outlets of a remainder of the series of at least two flash vessels are fluidly coupled between compressors of the series of at least two compressors.

### CROSS-REFERENCE TO RELATED APPLICATION

The present Application is a continuation of International Patent Cooperation Treaty Application No.: PCT/US2023/030626, entitled “Systems, Methods, and Apparatuses for Producing High-Pressure Steam,” filed Aug. 18, 2023, which claims priority to U.S. Provisional Patent Application No. 63/371,837, entitled “Steam Generating Mechanical Vapor Recompression Heat Pump,” filed Aug. 18, 2022, each of which is hereby incorporated by reference in its entirety for all purposes.

### TECHNICAL FIELD

The present disclosure relates generally to systems, methods, and apparatuses for producing high-pressure steam.

### BACKGROUND

Reducing on-site emissions in the industrial sector is critical to achieving desired greenhouse gas targets. For example, one set of greenhouse gas targets are set forth in California's Air Resources Board's AB32 and SB 32 greenhouse gas reduction targets, although this particular set of greenhouse gas targets should not be deemed the only targets to meet in the industrial sector. Presently, industrial manufacturing plants burn natural gas in a steam boiler to evaporate water and produce steam. Once the thermal energy of the steam is advantageously used, the thermal energy is removed from the process via a cooling water loop. This increases the temperature of the cooling water. The warmed cooling water is then typically sent to a cooling tower where the thermal energy is rejected to atmosphere, i.e., thrown away, in order to reduce the temperature of the cooling water.

In an effort to reach greenhouse gas targets and become carbon neutral, it is desired to increase industrial electrification. This includes electrification of the gas-powered boilers in various industries. For example, industrial sectors where improvement has been specifically identified include natural gas boilers to produce steam in the chemical sector, in the pulp and paper sectors, in association with food production, and still other, diverse industrial sectors. It is believed that these sectors, and others, could come closer to meeting energy goals.

A barrier to achieving desired energy goals is a lack of efficient and economically attractive technologies to electrify the massive thermal energy demands associated with steam production in industry including the above-mentioned sectors. State-of-the-art industrial heat pumps today are unable to reach the temperatures required to produce medium-high pressure saturated steam required by many industrial facilities. State-of-the-art electric boiler technologies, on the other hand, are indeed able to reach required temperatures and pressures, but they do so with a low coefficient of performance (COP) of 1.0 or less. This results in excessive electricity consumption, making these systems uneconomical to operate. Additionally, the high electricity consumption may add undue strain on the electric power grid.

It would also be desirable that development of an alternative electric boiler technology to meet the demand for medium to high pressure saturated steam could be implemented in a manner that limits custom engineering and specialized, one-off field assembly. Custom engineering and specialized field assembly drastically limit availability and increase cost. This, in turn, is believed to affect perception by the industrial customer of reliability. Further, customized solutions with specialized field assembly typically could potentially encounter very expensive downtime, and thus industrial customers are reluctant to try new technologies that may be perceived as possibly failing and/or causing undesired downtime.

Presently available, state-of-the-art heat pumps typically use hydrofluorocarbon (HFC) or hydrofluoro-olefin (HFO) refrigerant to produce thermal energy at temperatures up to 320° F. These known systems are unable to produce steam directly, but rather must be used in combination with an unfired steam generator, which introduces a 20° F. nominal temperature drop. As a result, the maximum saturated steam pressure these systems can produce is 3.5 barg (50 psig), which is not high enough to address the median pressure (3.5-20 barg) applications that are in demand throughout the manufacturing industry. In addition, these systems have a relatively low coefficient of performance of <3.0, resulting in high electricity demand and high operating costs. HFC refrigerants have high global warming potential, and HFO refrigerants have low global warming potential but high cost.

CO2-based heat pumps also utilize a low-cost and low-global warming potential refrigerant (CO2) but are limited to temperatures of approximately 238° F. or less due to the very high pressures required by the refrigerant. Although 238° F. is above the atmospheric boiling point of water, CO2-based heat pumps are not able to generate steam because these CO2-based heat pumps require a low fluid return temperature of 203° F. or less, and it is the fluid return temperature that generally dictates the ability to drive a steam generator.

Ammonia-based heat pumps are a more mature technology, but like CO2-based heat pumps, the high-pressure characteristics of the systems are limited to a maximum output temperature of approximately 203° F., which is unsuitable for steam generation. Ammonia-based systems can produce lower temperatures, and therefore, the ammonia-based systems are complementary rather than competitive to the heat pump systems desired for steam generation. For example, ammonia-based systems are commonly used to provide low temperature refrigeration in the food production industry and typically reject waste heat at temperatures ranging from about 85° F. to 100° F.

A need exists for an improved arrangement that addresses at least one or more of the above-described disadvantages, in a manner that is cost-effective, efficient, reliable, scalable, etc., as well as providing still other features and benefits.

### SUMMARY

Given the above background, what is needed in the art are systems, methods, and apparatuses to electrify the production of high-pressure steam. Various implementations of this application are efficient in energy consumption and manufacturing cost.

Accordingly, various aspects of the present disclosure are directed to systems, methods, and apparatuses for producing high-pressure steam. For instance, in some embodiments, the systems, methods, and apparatuses of the present disclosure are configured as a heat pump. In some embodiments, the heat pump of the systems, methods, and apparatuses of the present disclosure is configured as an open-cycle mechanical vapor recompression, high-pressure steam production heat pump. In some embodiments, the systems, methods, and apparatuses of the present disclosure are configured to replace conventional fossil-fuel (e.g., natural gas) boilers and/or conventional evaporative cooling towers, which not only reduces overall energy consumption but also provides water savings. More particularly, in some embodiments, the systems, methods, and apparatuses of the present disclosure provide for a high-efficiency, high-pressure heat pump that provides high-pressure steam by receiving hot water, such as cooling water from a facility, into a flash vessel train that is maintained at a pressure below the saturation pressure of the hot water in order to simultaneously cool the hot water and generate vapor (e.g., low-pressure steam). The flash vessel train is configured to supply the low-pressure steam to a compressor train that is configured to compress the low-pressure steam produced by the flash vessel train to produce the high-pressure steam at a desired pressure of the facility. Accordingly, in some embodiments, the systems, methods, and apparatus of the present disclosure produce high-pressure steam having a temperature of at most 426 degrees Fahrenheit (° F.) (219 degrees Celsius (° C.)), at a pressure of at most 315 pounds per square inch gauge (PSI) (19.0 Barg), and temperature lift of at most 330° F. (166° C.).

Furthermore, in some embodiments, the systems, methods, and apparatuses of the present disclosure provide for a baseline heat pump system that is modularly configurable based on interchangeable sub-assemblies of the compressor train and/or the flash vessel train of the heat pump system. Accordingly, in some embodiments, the systems, methods, and apparatuses of the present disclosure provide a standalone heat pump that is not deeply integrated into a process associated with a facility. Rather, the systems, methods, and apparatuses of the present disclosure connect with the facility at standard portions, which include a hot water source and a steam header, while otherwise operating external to the process associated with the facility.

Turning to more specific aspects, one aspect of the present disclosure is directed to providing a system for producing high-pressure steam. The system includes a compressor train. The compressor train includes a series of at least two compressors. Moreover, the compressor train includes an inlet of the compressor train. Furthermore, the compressor train includes an outlet of the compressor train that is configured to provide high-pressure steam to a facility. The system further includes a flash vessel train. The flash vessel train includes a series of at least two flash vessels, in which the series of at least two flash vessels further includes a terminal flash vessel at one end of the flash vessel train. Moreover, a vapor outlet of the terminal flash vessel is fluidly coupled to the inlet of the compressor train. Additionally, the system includes vapor outlets of a remainder of the series of at least two flash vessels that are fluidly coupled between compressors of the series of at least two compressors.

In some embodiments, the flash vessel train further includes an inlet of the flash vessel train that is configured to receive hot water received from the facility or a different facility.

In some embodiments, the remainder of the series of at least two flash vessels each includes a liquid outlet that is fluidly coupled to an inlet of another one of the series of at least two flash vessels.

In some embodiments, the terminal flash vessel includes a liquid outlet that is fluidly coupled to an outlet of the system.

In some embodiments, the system further includes a controller that is configured to maintain a temperature range of the flash vessel train between a temperature of the high-pressure steam and a temperature of the outlet of the system.

In some embodiments, the series of at least two compressors includes a centrifugal compressor. In some embodiments, the controller is configured to maintain the centrifugal compressor from stonewalling or surging.

In some embodiments, the terminal flash vessel includes a liquid outlet that is fluidly coupled to a repressurization pump. The repressurization pump is coupled to an outlet of the system.

In some embodiments, each flash vessel in the series of at least two flash vessels is configured to be maintained at an internal pressure less than a saturation pressure of hot water input into the respective flash vessel. Moreover, each flash vessel in the series of at least two flash vessels is configured to expand the hot water to produce low-pressure steam.

In some embodiments, the terminal flash vessel further includes an inlet that is configured to receive hot water. The hot water is received from the facility or a different facility.

In some embodiments, the terminal flash vessel further includes the inlet configured to receive hot water received from the facility or the different facility. Moreover, the terminal flash vessel further includes the liquid outlet fluidly that is coupled to a repressurization pump. The repressurization pump is further coupled to an outlet of the system. Moreover, the outlet of the system is fluidically coupled to a heat exchange mechanism associated with the hot water received from the facility or the different facility.

In some embodiments, the system further includes a desuperheater train that includes at least one desuperheater. Each desuperheater in the desuperheater train includes an outlet that is configured to inject hot water received from the facility or a different facility into the compressor train.

In some embodiments, at least one desuperheater of the desuperheater train is configured to control a flow rate of fluid through the desuperheater.

In some embodiments, in accordance with a determination that a temperature and/or a pressure associated with the compressor train satisfies a first pressure and/or a first temperature, the controller is configured to modify the flow rate of fluid through the desuperheater.

In some embodiments, the system includes a coefficient of performance greater than 65 percent of a corresponding Carnot efficiency.

In some embodiments, a flash vessel in the flash vessel train includes a continuous blowdown. The continuous blowdown is configured to remove a contaminant accommodated by the flash vessel.

In some embodiments, the system further includes a boiler that is disposed interposing between and fluidly coupled to an output of a terminal compressor in the compressor train and the outlet of the compressor train.

In some embodiments, the system further includes a steam accumulator that is disposed interposing between and fluidly coupled to an output of a terminal compressor in the compressor train and the outlet of the compressor train.

In some embodiments, the compressor train includes between two and twenty compressors, inclusive.

In some embodiments, the compressor train includes m compressors, in which m is an integer greater than two. Moreover, m is selected in accordance with a temperature of the high-pressure steam and a temperature of hot water received from the facility or a different facility.

In some embodiments, each compressor in the compressor train and each flash vessel in the flash vessel train share a one-to-one relationship.

In some embodiments, the compressor train includes a first compressor and a second compressor. The first compressor includes a first size, and the second compressor includes a second size less than the first size. Moreover, the first compressor is coupled upstream of the second compressor in the compressor train.

In some embodiments, the compressor train includes a third compressor that is interposing between and fluidly coupled to the first compressor and the second compressor. The third compressor includes either the first size or the second size.

In some embodiments, each compressor in the compressor train includes a compression ratio of less than 2.5.

In some embodiments, the outlet of the compressor train is configured to provide the high-pressure steam at a pressure between 50 pounds per square inch gauge (PSIg) (3.4 Barg) and 315 PSIg (21.7 Barg), inclusive.

In some embodiments, the controller is configured to modify a rotational velocity of a respective compressor in the compressor train, thereby maintaining a pressure of the outlet of the compressor train.

In some embodiments, a flash vessel in the flash vessel train comprises a second liquid outlet fluidly configured to selectively remove fluid from a corresponding flash vessel.

In some embodiments, the system further includes a controller in electronic communication with the second liquid outlet. In some such embodiments, the controller is configured to control the selective removal of fluid from the flash vessel.

In some embodiments, in accordance with a determination that a temperature and/or a pressure associated with the compressor train satisfies a first pressure and/or a first temperature, the controller is configured to modify a flow rate of fluid through the desuperheater.

In some embodiments, the series of at least two compressors includes at least four compressors. In some such embodiments, the at least four compressors is disposed in a herringbone array configuration.

In some embodiments, the system further includes a water loop. In some embodiments, the water loop includes an upstream portion and a downstream portion. In some embodiments, the downstream portion is configured to receive the hot water from the same or a different facility. In some embodiments, the upstream portion configured to supply cooling water to the same or the different facility. Moreover, in some embodiments, the water loop is heated by the same or the different facility.

The systems, methods, and apparatuses of the present disclosure have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a block diagram of an example high-pressure steam production heat pump system, in which dashed boxes represent optional elements, in accordance with some embodiments.

FIG. 1B is a block diagram of an example high-pressure steam production heat pump system, in which dashed boxes represent optional elements, in accordance with some embodiments.

FIGS. 2A, 2B, 3, 4, 5A, 5B, and 5C are block diagrams of example high-pressure steam production heat pump systems, in which dashed boxes represent optional elements, in accordance with some embodiments.

FIG. 6 is a chart diagram depicting various parameters associated with a variety of high-pressure steam production heat pump systems, in accordance with some embodiments.

FIG. 7 is a chart diagram depicting performance of high-pressure steam production heat pump system in comparison against a variety of conventional technologies, in accordance with some embodiments.

FIG. 8 is a flow chart of an example method for producing high-pressure steam, in which dashed boxes represent optional elements in the flow chart, in accordance with some embodiments.

FIG. 9 is a block diagram illustrating an example computer system that is applied in a high-pressure steam production heat pump system, in accordance with some embodiments.

In the figures, reference numbers refer to the same or equivalent parts of the present invention throughout the several figures of the drawing.

### DESCRIPTION OF EMBODIMENTS

Systems, methods, and apparatuses for producing high-pressure steam are provided. A compressor train includes a series of at least two compressors, an inlet of the compressor train, and an outlet of the compressor train. In some embodiments, each compressor of the compressor train is a centrifugal compressor. The outlet of the compressor train is configured to provide high-pressure steam to a facility, which allows for the compressor train to be coupled to the facility. In some embodiments, the compressor train is coupled (e.g., directly connected) to the facility. A flash vessel train includes a series of at least two flash vessels. The series of at least two flash vessels includes a terminal flash vessel at one end of the flash vessel train. In some embodiments, the flash vessel train is configured to transform heat associated with hot water received by the system into latent heat. Furthermore, a vapor outlet of the terminal flash vessel is fluidly coupled to the inlet of the compressor train. Additionally, the system includes vapor outlets of a remainder of the series of at least two flash vessels that are fluidly coupled between compressors of the series of at least two compressors. In this way, each flash vessel of the flash vessel train produces a low-pressure steam that is received by a respective compressor of the compressor train in order to increase a pressure of the low-pressure steam, such as in order to produce high-pressure steam.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, and components have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For instance, a first compressor could be termed a second compressor, and, similarly, a second compressor could be termed a first compressor, without departing from the scope of the present disclosure. The first compressor and the second compressor are both compressors, but they are not the same compressor.

The terminology used in the present disclosure is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions below are not intended to be exhaustive or to limit the implementations to the precise forms disclosed. Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case- and business-related constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

As used herein, the term “epoch” means a predefined period of time.

Furthermore, the terms “compressor” and “blower” are used interchangeably herein unless expressly stated otherwise.

The terms “flash vessel” and “knockout drum” are used interchangeably herein unless expressly stated otherwise.

The terms “steam” and “water vapor” are used interchangeably herein unless expressly stated otherwise.

Moreover, the term “stream” as used herein means any material moving or en route, directly or indirectly, from one location to another. In some embodiments, a stream is still a stream even if it is temporarily stationary for any epoch. In some embodiments, it will be understood that if the present disclosure refers to a particular stream, this does not necessarily refer to a single pipe or other physical conveyance.

Furthermore, when a reference number is given an “ith” denotation, the reference number refers to a generic component, set, or embodiment. For instance, a compressor termed “compressor i” refers to the ith compressor in a plurality of compressors (e.g., a compressor 204-i in a plurality of compressors 204).

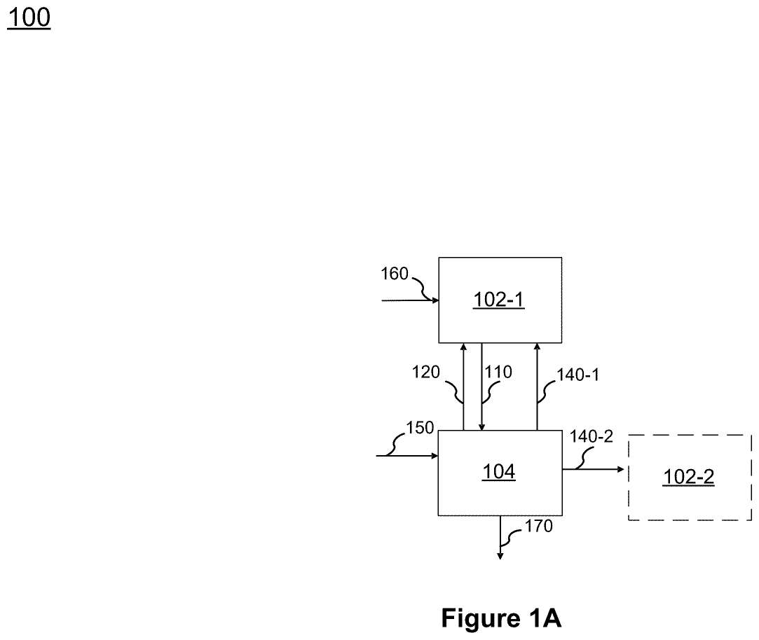

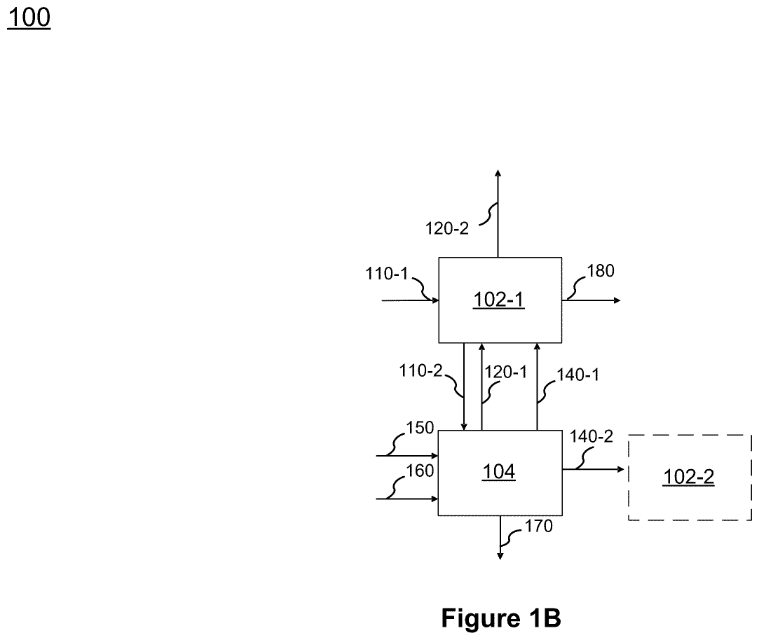

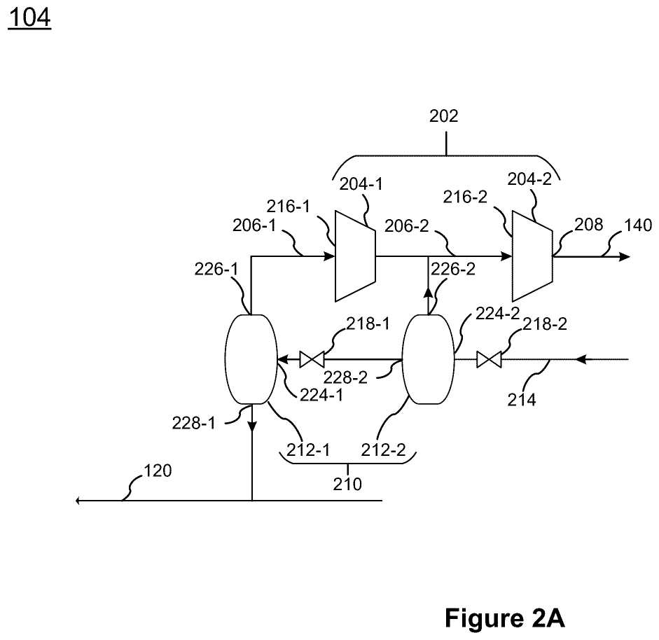

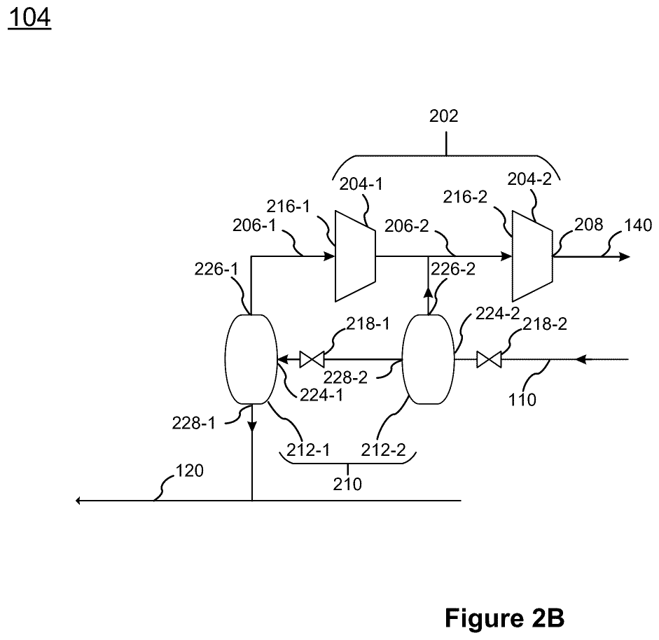

FIGS. 1A and 1B each represent a block diagram of an example high-pressure steam production heat pump system, in which dashed boxes represent optional elements, in accordance with some embodiments. FIGS. 2A-5C are block diagrams of detailed example high-pressure steam production heat pump systems, in which dashed boxes represent optional elements, in accordance with some embodiments. Referring to FIGS. 1A and 1B, in some embodiments, the present disclosure is directed to providing a system (e.g., system 104 of any of FIG. 1A-7, etc.) for producing high-pressure steam (e.g., high-pressure steam 140-1 or 140-2 of FIG. 1A, high pressure steam 140 of FIG. 1B, high-pressure steam 140 of any of FIGS. 2A-7, etc.).

In some embodiments, the system 104 is coupled to one or more facilities (e.g., first facility 102-1 of FIG. 1A, second facility 102 of FIG. 1B, etc.). For instance, in some embodiments, the system 104 is associated with a first facility 102-1 and disposed proximate to the first facility 102-1, which allows the system 104 to utilize one or more resources from the first facility 102-1. Moreover, in some embodiments, the system 104 is associated with the first facility 102-1 and disposed proximate to the first facility 102-1 in order to allow for the system 104 to provide the high-pressure steam 140 produced at the system 104 to the first facility 102-1, such as by coupling to an existing steam header of the first facility 102-1. However, the present disclosure is not limited thereto.

Referring to FIGS. 2A through 5C, the system 104 includes a compressor train (e.g., compressor train 202 of any of FIGS. 2A-5C, etc.) and a flash vessel train (e.g., flash vessel 212 of any of FIGS. 1A-5B, etc.), which collectively are utilized by the system 104 to produce the high-pressure steam 140 for a facility 102.

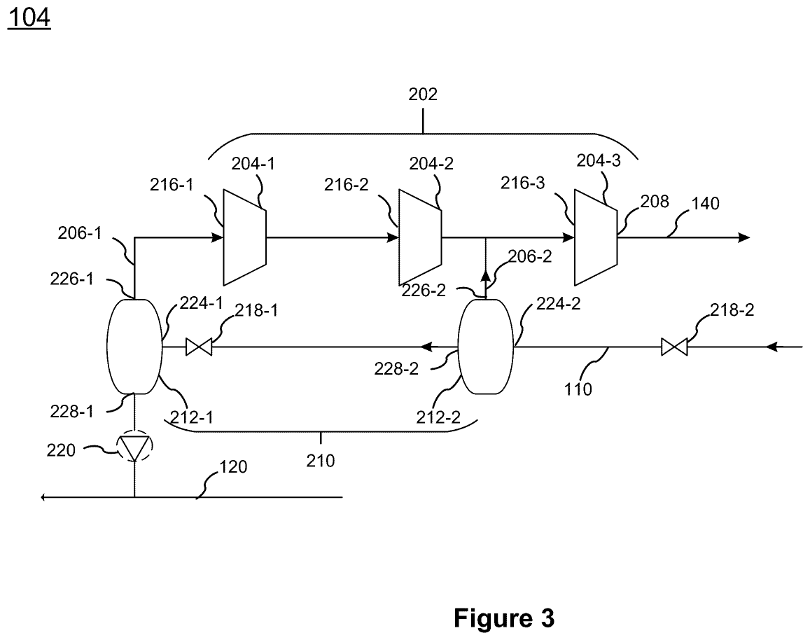

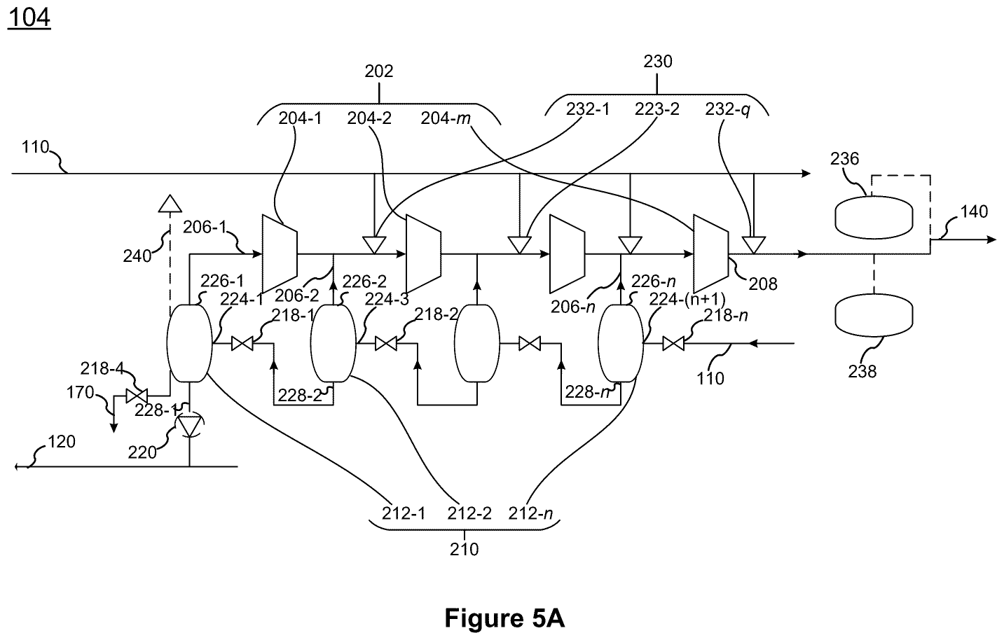

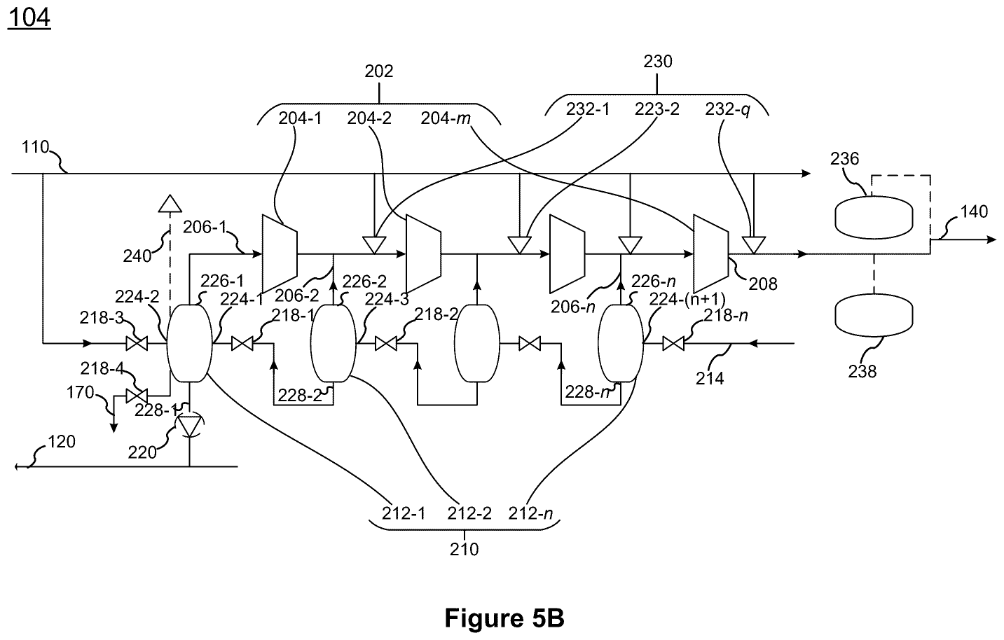

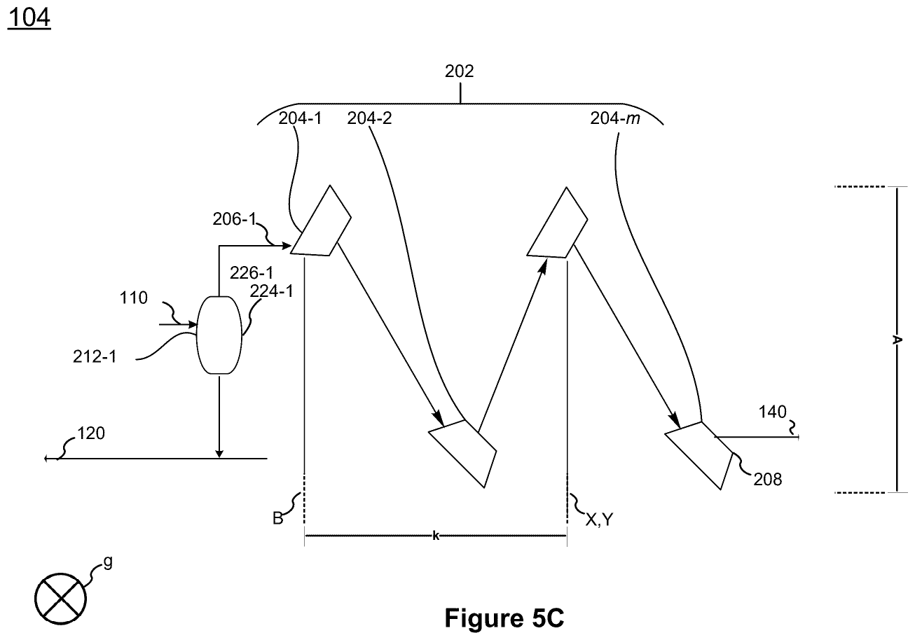

One of skill in the art of the present disclosure will appreciate that temperature rise and mechanical stresses within a respective compressor limit the maximum pressure differential provided by any stage of the respective compressor. Accordingly, in order to provide the high-pressure steam 140 that is utilizable by the facility 102, the compressor train 202 includes a series of at least two compressors (e.g., first compressor 204-1 of any of FIGS. 2A-5C, second compressor 204-2 of any of FIGS. 2A-5C, third compressor 204-3 of any of FIGS. 3-5C, . . . , compressor 204-m of FIG. 5C, etc.). For instance, in some embodiments, the compressor train 202 includes between two and twenty compressors 204 (e.g., two compressors 204, three compressors 204, . . . , twenty compressors 204, etc.), between two and seventeen compressors 204, between two and fifteen compressors 204, between two and twelve compressors 204, between two and nine compressors 204, between two and six compressors 204, between two and three compressors 204, between three and twenty compressors 204, between three and seventeen compressors 204, between three and fifteen compressors 204, between three and twelve compressors 204, between three and nine compressors 204, between three and six compressors 204, between five and twenty compressors 204, between five and seventeen compressors 204, between five and fifteen compressors 204, between five and twelve compressors 204, between five and nine compressors 204, between five and six compressors 204, between seven and twenty compressors 204, between seven and seventeen compressors 204, between seven and fifteen compressors 204, between seven and twelve compressors 204, between seven and nine compressors 204, between nine and twenty compressors 204, between nine and seventeen compressors 204, between nine and fifteen compressors 204, between nine and twelve compressors 204, between eleven and twenty compressors 204, between eleven and seventeen compressors 204, between eleven and fifteen compressors 204, between eleven and twelve compressors 204, between thirteen and twenty compressors 204, between thirteen and seventeen compressors 204, between thirteen and fifteen compressors 204, between fifteen and twenty compressors 204, between fifteen and seventeen compressors 204, or between seventeen and twenty compressors 204, inclusive. In some embodiments, the compressor train 202 includes at least two compressors 204, at least three compressors 204, at least four compressors 204, at least five compressors 204, at least six compressors 204, at least seven compressors 204, at least eight compressors 204, at least nine compressors 204, at least ten compressors 204, at least eleven compressors 204, at least twelve compressors 204, at least thirteen compressors 204, at least fourteen compressors 204, at least fifteen compressors 204, at least sixteen compressors 204, at least seventeen compressors 204, at least eighteen compressors 204, at least nineteen compressors 204, or at least twenty compressors 204. In some embodiments, the compressor train 202 includes at most two compressors 204, at most three compressors 204, at most four compressors 204, at most five compressors 204, at most six compressors 204, at most seven compressors 204, at most eight compressors 204, at most nine compressors 204, at most ten compressors 204, at most eleven compressors 204, at most twelve compressors 204, at most thirteen compressors 204, at most fourteen compressors 204, at most fifteen compressors 204, at most sixteen compressors 204, at most seventeen compressors 204, at most eighteen compressors 204, at most nineteen compressors 204, or at most twenty compressors 204.

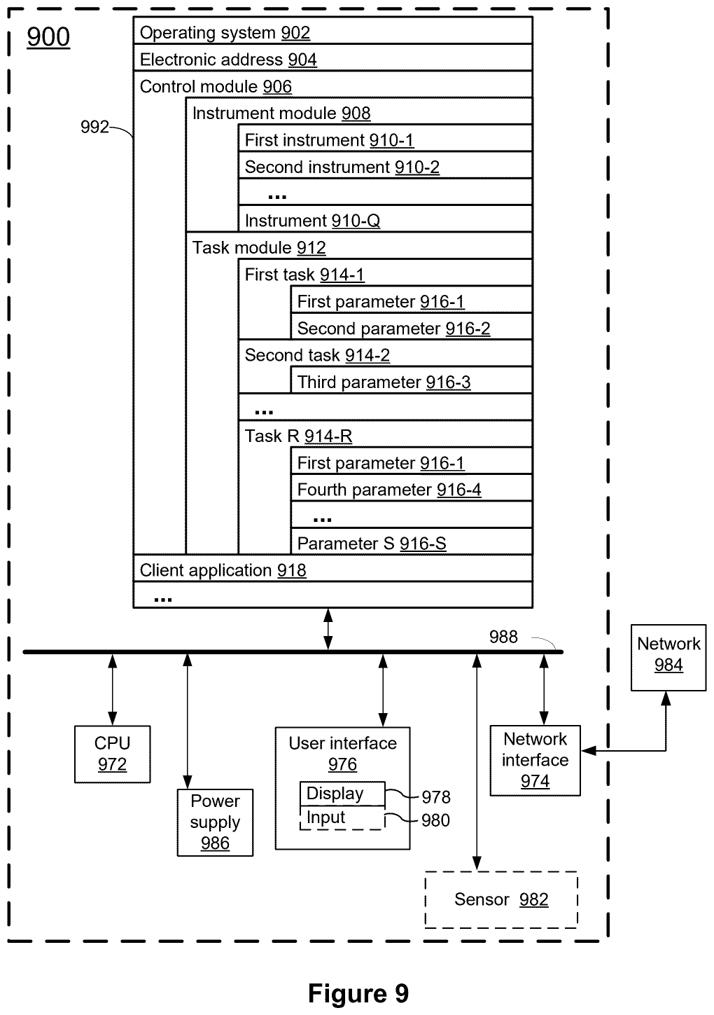

In some embodiments, the compressor train 202 includes m compressors 204, in which m is an integer, such as an integer greater than two. In some embodiments, m is at least two and less than twenty-one. Moreover, in some embodiments, m is selected for the system 104 in accordance with one or more input parameters (e.g., parameters 916 of FIG. 9) of the system 104 and/or one or more output parameters 916 of the system 104. For instance, in some embodiments, m is selected in accordance with a temperature of the high-pressure steam 140 that is produced by the system 104 and a temperature of hot water received from the facility 102 or the different facility 102 by the system 104. In some embodiments, m is selected in accordance with a lift (e.g., difference) between the temperature of the high-pressure steam 140 that is produced by the system 104 and the temperature of hot water received from the hot water source 110 associated with the facility 102 or the different facility 102 by the system 104. For instance, in some embodiments, m is selected in order to provide the lift between 60° F. (15.6° C.) and 330° F. (165° C.), between 60° F. (15.6° C.) and 300° F. (149° C.), between 60° F. (15.6° C.) and 270° F. (135° C.), between 60° F. (15.6° C.) and 250° F. (121° C.), between 60° F. (15.6° C.) and 220° F. (65.6° C.), between 60° F. (15.6° C.) and 205° F. (96.1° C.), between 60° F. (15.6° C.) and 190° F. (87.8° C.), between 60° F. (15.6° C.) and 175° F. (79.4° C.), between 60° F. (15.6° C.) and 150° F. (65.6° C.), between 60° F. (15.6° C.) and 135° F. (57.2° C.), between 60° F. (15.6° C.) and 120° F. (48.9° C.), between 60° F. (15.6° C.) and 105° F. (40.6° C.), between 60° F. (15.6° C.) and 90° F. (32.2° C.), between 60° F. (15.6° C.) and 75° F. (23.9° F.), between 80° F. (26.7° C.) and 330° F. (165° C.), between 80° F. (26.7° C.) and 300° F. (149° C.), between 80° F. (26.7° C.) and 270° F. (135° C.), between 80° F. (26.7° C.) and 250° F. (121° C.), between 80° F. (26.7° C.) and 220° F. (65.6° C.), between 80° F. (26.7° C.) and 205° F. (96.1° C.), between 80° F. (26.7° C.) and 190° F. (87.8° C.), between 80° F. (26.7° C.) and 175° F. (79.4° C.), between 80° F. (26.7° C.) and 150° F. (65.6° C.), between 80° F. (26.7° C.) and 135° F. (57.2° C.), between 80° F. (26.7° C.) and 120° F. (48.9° C.), between 80° F. (26.7° C.) and 105° F. (40.6° C.), between 80° F. (26.7° C.) and 90° F. (32.2° C.), between 100° F. (37.8° C.) and 330° F. (165° C.), between 100° F. (37.8° C.) and 300° F. (149° C.), between 100° F. (37.8° C.) and 270° F. (135° C.), between 100° F. (37.8° C.) and 250° F. (121° C.), between 100° F. (37.8° C.) and 220° F. (65.6° C.), between 100° F. (37.8° C.) and 205° F. (96.1° C.), between 100° F. (37.8° C.) and 190° F. (87.8° C.), between 100° F. (37.8° C.) and 175° F. (79.4° C.), between 100° F. (37.8° C.) and 150° F. (65.6° C.), between 100° F. (37.8° C.) and 135° F. (57.2° C.), between 100° F. (37.8° C.) and 120° F. (48.9° C.), between 100° F. (37.8° C.) and 105° F. (40.6° C.), between 120° F. (48.9° C.) and 330° F. (165° C.), between 120° F. (48.9° C.) and 300° F. (149° C.), between 120° F. (48.9° C.) and 270° F. (135° C.), between 120° F. (48.9° C.) and 250° F. (121° C.), between 120° F. (48.9° C.) and 220° F. (65.6° C.), between 120° F. (48.9° C.) and 205° F. (96.1° C.), between 120° F. (48.9° C.) and 190° F. (87.8° C.), between 120° F. (48.9° C.) and 175° F. (79.4° C.), between 120° F. (48.9° C.) and 150° F. (65.6° C.), between 120° F. (48.9° C.) and 135° F. (57.2° C.), between 140° F. (60.0° C.) and 330° F. (165° C.), between 140° F. (60.0° C.) and 300° F. (149° C.), between 140° F. (60.0° C.) and 270° F. (135° C.), between 140° F. (60.0° C.) and 250° F. (121° C.), between 140° F. (60.0° C.) and 220° F. (65.6° C.), between 140° F. (60.0° C.) and 205° F. (96.1° C.), between 140° F. (60.0° C.) and 190° F. (87.8° C.), between 140° F. (60.0° C.) and 175° F. (79.4° C.), between 140° F. (60.0° C.) and 150° F. (65.6° C.), between 175° F. (79.4° C.) and 330° F. (165° C.), between 175° F. (79.4° C.) and 300° F. (149° C.), between 175° F. (79.4° C.) and 270° F. (135° C.), between 175° F. (79.4° C.) and 250° F. (121° C.), between 175° F. (79.4° C.), and 220° F. (65.6° C.), between 175° F. (79.4° C.), and 205° F. (96.1° C.), between 175° F. (79.4° C.), and 190° F. (87.8° C.), between 190° F. (87.8° C.) and 220° F. (65.6° C.), between 190° F. (87.8° C.) and 330° F. (165° C.), between 190° F. (87.8° C.) and 300° F. (149° C.), between 190° F. (87.8° C.) and 270° F. (135° C.), between 190° F. (87.8° C.) and 250° F. (121° C.), between 190° F. (87.8° C.) and 205° F. (96.1° C.), between 205° F. (96.1° C.) and 330° F. (165° C.), between 205° F. (96.1° C.) and 300° F. (149° C.), between 205° F. (96.1° C.) and 270° F. (135° C.), between 205° F. (96.1° C.) and 250° F. (121° C.), between 205° F. (96.1° C.) and 220° F. (65.6° C.), between 250° F. (121° C.) and 330° F. (165° C.), between 250° F. (121° C.) and 300° F. (149° C.), between 250° F. (121° C.) and 270° F. (135° C.), or between 270° F. (135° C.), and 330° F. (165° C.), inclusive. In some embodiments, m is selected in order to provide the lift of at least 60° F. (15.6° C.), at least 65° F. (18.3° C.), at least 70° F. (21.1° C.), at least 75° F. (23.9° C.), at least 80° F. (26.7° C.), at least 85° F. (29.4° C.), at least 90° F. (32.2° C.), at least 95° F. (35.0° C.), at least 100° F. (37.8° C.), 105° F. (40.6° C.), at least 110° F. (43.3° C.), at least 115° F. (46.1° C.), at least 120° F. (48.9° C.), at least 125° F. (51.7° C.), at least 130° F. (54.4° C.), at least 135° F. (57.2° C.), at least 140° F. (60.0° C.), at least 145° F. (62.8° C.), at least 150° F. (65.6° C.), at least 155° F. (68.3° C.), at least 160° F. (71.1° C.), at least 165° F. (73.9° C.), at least 170° F. (76.7° C.), at least 175° F. (79.4° C.), at least 180° F. (82.2° C.), at least 185° F. (85.0° C.), at least 190° F. (87.8° C.), at least 195° F. (90.6° C.), at least 200° F. (93.3° C.), at least 205° F. (96.1° C.), at least 210° F. (98.9° C.), at least 215° F. (102° C.), at least 220° F. (104° C.), at least 250° F. (121° C.), at least 270° F. (135° C.), at least 300° F. (149° C.), or at least 330° F. (165° C.). In some embodiments, m is selected in order to provide the lift of at most 60° F. (15.6° C.), at most 65° F. (18.3° C.), at most 70° F. (21.1° C.), at most 75° F. (23.9° C.), at most 80° F. (26.7° C.), at most 85° F. (29.4° C.), at most 90° F. (32.2° C.), at most 95° F. (35.0° C.), at most 100° F. (37.8° C.), 105° F. (40.6° C.), at most 110° F. (43.3° C.), at most 115° F. (46.1° C.), at most 120° F. (48.9° C.), at most 125° F. (51.7° C.), at most 130° F. (54.4° C.), at most 135° F. (57.2° C.), at most 140° F. (60.0° C.), at most 145° F. (62.8° C.), at most 150° F. (65.6° C.), at most 155° F. (68.3° C.), at most 160° F. (71.1° C.), at most 165° F. (73.9° C.), at most 170° F. (76.7° C.), at most 175° F. (79.4° C.), at most 180° F. (82.2° C.), at most 185° F. (85.0° C.), at most 190° F. (87.8° C.), at most 195° F. (90.6° C.), at most 200° F. (93.3° C.), at most 205° F. (96.1° C.), at most 210° F. (98.9° C.), at most 215° F. (102° C.), at most 220° F. (104° C.), at most 250° F. (121° C.), at most 270° F. (135° C.), at most 300° F. (149° C.), or at most 330° F. (165° C.).

In some embodiments, the series of at least two compressors 204 is configured such that the at least two compressors 204 in the series of at least two compressors 204 are fluidically coupled in series. In some embodiments, the series of at least two compressors 204 are coupled, at least in part, fluidically in series, which allows for a stream of medium to flow from a first compressor 204-1 in the series of at least two compressors 204 into a second compressor 204-2 in the series of at least two compressors 204. For instance, in some embodiments, the series of at least two compressors 204 includes a pathline through both the first compressor 204-1 and the second compressor 204-2 when the series of at least two compressors 204 are coupled, at least in part, fluidically in series. In some embodiments, the series of at least two compressors 204 is configured such that each compressor in the series of at least two compressors 204 is disposed in a straight line, a substantially straight line, an arc line, or a substantially arc line. In some embodiments, the series of at least two compressors 204 is configured such that each compressor in the series of at least two compressors 204 is disposed in an array, such as an array of two or more rows of parallel, or substantially parallel lines. For instance, in some embodiments, the series of at least two compressors 204 is configured such that each compressor in the series of at least two compressors 204 is disposed in a herringbone array, in which a first line associated with a first set of compressors 204 in the series of at least two compressors 204 has a first slope and a second set of compressors 204 in the series of at least two compressors 204 has a second slope opposite the first slope. As a non-limiting example, referring briefly to FIG. 5C, in some embodiments, the series of at least two compressors 204 includes at least four compressors 204 (e.g., first compressor 204-1, second compressor 204-2, . . . , compressor 204-m of FIG. 5B). In some such embodiments, the at least four compressors 204 of the compressor train 202 is disposed in a herringbone array configuration, such that the outlet of a first set of compressors 204 in the series of at least four compressors 204 has a first slope and a second set of compressors 204 in the series of at least four compressors 204, in which the second slope is tangential, substantially tangential, orthogonal, or substantially orthogonal to the first slope. In some embodiments, the second slope is the reciprocal of the first slope. In some embodiments, the first slope has a 45 degree difference from the second slope or approximately 45 degree difference from the second slope. In some embodiments, the herringbone configuration of the compressor train 202 is configured such that the steam generated by each compressor 204 flows in a first direction. In some such embodiments, the first set of compressors 204 in the series of at least four compressors 204 is configured to change a direction of the flow in a second direction and the second set of compressors 204 in the series of at least four compressors 204 is configured to change a direction of the flow in a third direction, in which the first direction, the second direction, and the third direction and each different directions. For instance, in some embodiments, the herringbone configuration of the compressor train 202 is configured such that the steam generated by each compressor 204 flows in a first horizontal direction, the first set of compressors 204 in the series of at least four compressors 204 is configured to change a direction of the flow in a second vertical direction and the second set of compressors 204 in the series of at least four compressors 204 is configured to change a direction of the flow in a third vertical direction, in which the second vertical direction and the third vertical direction are different. In some embodiments, the second vertical direction is against gravity (e.g., g of FIG. 5C, which is has a vector direction into the page of FIG. 5C) and the third vertical direction is with gravity. However, the present disclosure is not limited thereto. In some embodiments, the herringbone configuration of the compressor train 202 is configured such that the steam 140,206 generated by each compressor 204 flows in a first horizontal direction, the first set of compressors 204 in the series of at least four compressors 204 is configured to change a direction of the flow in a second horizontal direction and the second set of compressors 204 in the series of at least four compressors 204 is configured to change a direction of the flow in a third horizontal direction, in which the second horizontal direction and the third horizontal are different. In some embodiments, the herringbone configuration is configured to maintain the flow through the compressor train 204 at a constant, or substantially constant, height, such that a uniform or substantially uniform gravitational force is exerted on the compressor train 202. In some embodiments, the herringbone configuration of the compressor train 202 is configured provide an array of compressors disposed about a line (Y), in which each compressor 204 of the compressor train 202 is disposed at a unique position about the line in accordance with a first constant amplitude and a first constant frequency. For instance, in some embodiments, the herringbone configuration of the compressor train 202 is configured provide an array of compressors disposed in accordance with a function of:

Y=B+(A*sin(k*X)), in which Y is first position of a respective compressor 204 of the compressor train 202, B is a position of a terminal compressor 204 of the compressor train 202, A is the constant amplitude, k is the constant frequency, and X is a second position of the respective compressor. However, the present disclosure is not limited thereto.

In some embodiments, the compressor train 202 includes the first compressor 202-1 and the second compressor 202-2. The first compressor 202-1 includes a first optimal inlet volumetric flow rate. Moreover, in some such embodiment, the second compressor 202-2 includes a second optimal inlet volumetric flow rate that is greater than the first optimal inlet volumetric flow rate of the first compressor 202-1. Moreover, in some such embodiments, the first compressor 204-1 is coupled upstream of the second compressor 204-2 in the compressor train 202.

Referring to FIGS. 2A and 2B, in some embodiments, the first compressor 204-1 is associated with a first size and the second compressor 204-2 is associated with a second size. In some embodiments, the second size is equal to the first size. Alternatively, in some embodiments, the second size is different from the first size. For instance, in some embodiments, the first compressor 204-1 has a first diameter and the second compressor has a second diameter different from the first diameter. In some embodiments, the first diameter is greater than the second diameter. In some embodiments, the second diameter is the same as the first diameter. For instance, in some embodiments, the first diameter is a number k selected between 0.1 meters and 1.6 meters and the second diameter is a number l selected between 0.1 meters and 1.6 meters, in which k and 1 are different numbers. However, the present disclosure is not limited thereto. In some embodiments, a third compressor 204-3 has the second diameter and/or a third diameter greater than the second diameter. In some such embodiments, the third compressor is disposed upstream from the first compressor 204-1 and the second compressor 204-2. In some embodiments, the third compressor is disposed downstream from the first compressor 204-1 and upstream from the second compressor 204-2, such that the third compressor is interposing between and fluidly coupled to the first compressor 204-1 and the second compressor 204-2. In some embodiments, the third compressor is fluidly coupled in series to the first compressor 204-1 and the second compressor 204-2. However, the present disclosure is not limited thereto.

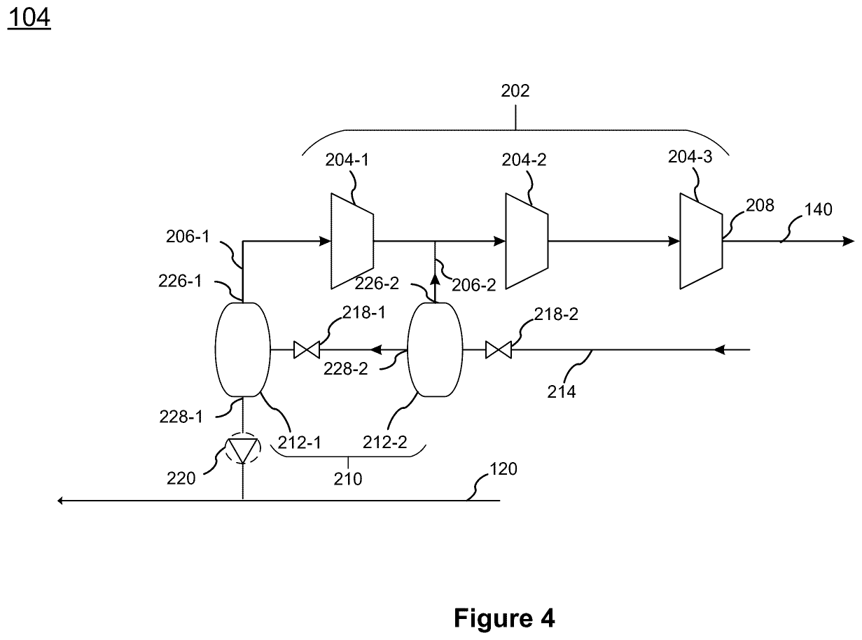

In some embodiments, the compressor train 202 includes a third compressor 204-3 that is adjacent to and interposing between the first compressor 204-1 and the second compressor 204-2. As a non-limiting example, referring briefly to FIG. 4, the compressor train 202 includes the second compressor 204-2 that is adjacent to and interposing between the first compressor 204-1 and the third compressor 204-3 of the system 104 of FIG. 4. However, the present disclosure is not limited thereto. In some embodiments, the third compressor 204-3 includes either the first optimal inlet volumetric flow rate or the second optimal inlet volumetric flow rate.

In some embodiments, each compressor 204 in the compressor train 202 includes a compression ratio of less than 2.5. For instance, in some embodiments, the compression ratio of a respective compressor 204 is defined by a ratio of an absolute discharge pressure against the absolute suction pressure of the respective compressor 204. Said otherwise, in some such embodiments, the compression ratio of the respective compressor 204 is the ratio of a pressure at an inlet of the respective compressor 204 (e.g., inlet 224) and a pressure of an outlet of the respective compressor 204. Accordingly, a higher compression ratio yields a greater pressure increase when compressing a fluid via the respective compressor 204.

In some embodiments, the series of at least two compressors 204 includes one or more centrifugal compressors 204, one or more piston compressors 204, one or more rotary compressors 204, one or more screw compressors 204, or a combination thereof.

Furthermore, in some embodiments, each compressor 204 in the series of at least two compressors 204 of the compressor train 202 is a single-stage compressor 204. For instance, in some embodiments, each stage of each compressor 204 is associated with a corresponding motor (e.g., power supply 986 of FIG. 9) and/or a corresponding variable frequency drive (VFD) controller (e.g., controller 906 of FIG. 9), which allows for a respective compressor 204 to be individually operated distinctly from the remainder of the series of at least two compressors 204. In some embodiments, an impeller velocity (e.g., rotational speed) is controlled by a controller (e.g., controller 906 of FIG. 9), which controls the impeller velocity via the VFD associated with the corresponding motor. For instance, in some embodiments, the impeller velocity of each compressor 204 of the compressor train 202 is individually controlled (e.g., by controller 906 of FIG. 9), in order to maintain a constant pressure for supplying the high-pressure steam 140 to the facility. However, the present disclosure is not limited thereto.

In some embodiments, the controller 1906 is configured to modify a rotational velocity of a respective compressor 204 in the series of at least two compressors 204 of the compressor train 202. For instance, in some embodiments, the controller 1906 is configured to modify the rotational velocity of each respective compressor 204 in the compressor train 202 in order to maintain a pressure of the outlet of the compressor train 202, such as in order to maintain an outlet pressure of the high-pressure steam 140 at a pressure of at least 80 PSI. However, the present disclosure is not limited there. For instance, in some embodiments, the controller is configured to increase a rotational velocity of the first compressor 202-1, decrease the rotational velocity of the first compressor 202-1, increase the rotational velocity of the second compressor 202-2, decrease the rotational velocity of the second compressor 202-2, or a combination thereof (e.g., both decrease the rotational velocity of the first compressor 202-1 and increase the rotational velocity of the second compressor 202-2, etc.). However, the present disclosure is not limited thereto.

Moreover, the compressor train 202 includes an inlet (e.g., first inlet 216-1 of any of FIGS. 2A-5B, etc.) of the compressor train 202, which allows the compressor train 202 to receive a stream of medium, such as low-pressure steam produced by a respective flash vessel of the flash vessel train 210 (e.g., first low-pressure steam 206-1 produced by first flash vessel 212-1 of any of FIGS. 2A-5B, second low-pressure steam 206-2 produced by second flash vessel 212-2 of any of FIGS. 2A-5B, . . . , low-pressure steam n 206-n produced by flash vessel n 212-n, etc.).

Furthermore, the compressor train 202 includes an outlet (e.g., outlet 208 of any of FIGS. 2A-5B, etc.) of the compressor train 202. In some embodiments, the outlet 208 of the compressor train 202 is configured to provide high-pressure steam to a facility 102. For instance, in some embodiments, the outlet 208 of the compressor train 202 is configured to couple to an existing steam header of the facility 102, which allows for the system 104 to provide the high-pressure steam 140 without needing to reconfigure the facility 102, such as by requiring a new steam header at the facility 102.

Referring to FIGS. 3A-5C, in some embodiments, three or more compressors 204 of the compressor train 202 have decreasing sizes along a forward direction extending from the inlet to the outlet of the compressor train 202. In some embodiments, an upstream compressor is located closer to the inlet than a downstream compressor in the compressor chain 202, and a size of the upstream compressor is less than or equal to a size of the downstream compressor. In some embodiments, the three or more compressors 204 of the compressor train 202 have identical sizes along a direction extending from the inlet to the outlet of the compressor chain. In some embodiments, all compressors 204 in the compressor train 202 are equal to or smaller than a predefined compressor size limit. In some embodiments, during the course of designing the system 104, a number of compressors 204 in the compressor train 202 is determined based on steam parameters 116 (e.g., pressure and temperature) measured at the inlet and outlet of the compressor train 202. Sizes of the compressors 204 in the compressor train 202 increases along a backward direction extending from the outlet to the inlet of the compressor train 202. In some situations, a subset of compressors 204 (e.g., 2 compressors) coupled to the inlet has the same size equal to the predefined compressor size limit. In accordance with a determination that the subset of compressors 204 includes two or more compressors 204, one or more flash vessels 212 are added to facilitate a corresponding cascaded compression process implemented by the compressor train 202.

In some embodiments, the outlet of the compressor train 202 is configured to provide the high-pressure steam 140 at a pressure between 50 PSI (3.44 Bar) and 315 PSI (21.7 Bar). For instance, in some embodiments, the compressor train 202 is configured to provide the high-pressure steam 140 to an existing steam header of a facility 102 at a pressure between 50 PSI (3.44 Bar) and 300 PSI (20.7 Bar), between 50 PSI (3.44 Bar) and 275 PSI (19.0 Bar), between 50 PSI (3.44 Bar) and 250 PSI (17.2 Bar), between 50 PSI (3.44 Bar) and 225 PSI (15.5 Bar), between 50 PSI (3.44 Bar) and 200 PSI (13.8 Bar), between 50 PSI (3.44 Bar) and 175 PSI (12.1 Bar), between 50 PSI (3.44 Bar) and 150 PSI (10.3 Bar), between 50 PSI (3.44 Bar) and 125 PSI (8.62 Bar), between 50 PSI (3.44 Bar) and 100 PSI (6.89 Bar), between 110 PSI (7.58 Bar) and 315 PSI (21.7 Bar), between 110 PSI (7.58 Bar) and 300 PSI (20.7 Bar), between 110 PSI (7.58 Bar) and 275 PSI (19.0 Bar), between 110 PSI (7.58 Bar) and 250 PSI (17.2 Bar), between 110 PSI (7.58 Bar) and 225 PSI (15.5 Bar), between 110 PSI (7.58 Bar) and 200 PSI (13.8 Bar), between 110 PSI (7.58 Bar) and 175 PSI (12.1 Bar), between 110 PSI (7.58 Bar) and 150 PSI (10.3 Bar), between 110 PSI (7.58 Bar) and 125 PSI (8.62 Bar), between 170 PSI (11.7 Bar) and 315 PSI (21.7 Bar), between 170 PSI (11.7 Bar) and 300 PSI (20.7 Bar), between 170 PSI (11.7 Bar) and 275 PSI (19.0 Bar), between 170 PSI (11.7 Bar) and 250 PSI (17.2 Bar), between 170 PSI (11.7 Bar) and 225 PSI (15.5 Bar), between 170 PSI (11.7 Bar) and 200 PSI (13.8 Bar), between 170 PSI (11.7 Bar) and 175 PSI (12.1 Bar), between 230 PSI (15.6 Bar) and 315 PSI (21.7 Bar), 230 PSI (15.6 Bar) and 300 PSI (20.7 Bar), between 230 PSI (15.6 Bar) and 275 PSI (19.0 Bar), between 230 PSI (15.6 Bar) and 250 PSI (17.2 Bar), between 290 PSI (20.0 Bar) and 315 PSI (21.7 Bar), or between 290 PSI (20.0 Bar) and 300 PSI (20.7 Bar), inclusive. In some embodiments, the compressor train 202 is configured to provide the high-pressure steam 140 to an existing steam header of a facility 102 at a pressure of at least 50 PSI (3.44 Bar), at least 70 PSI (4.83 Bar), at least 90 PSI (6.21 Bar), at least 110 PSI (7.58 Bar), at least 130 PSI (8.96 Bar), at least 150 PSI (10.3 Bar), 170 PSI (11.7 Bar), at least 190 PSI (13.1 Bar), at least 210 PSI (14.5 Bar), at least 230 PSI (15.6 Bar), at least 250 PSI (17.2 Bar), at least 270 PSI (18.6 Bar), at least 290 PSI (20.0 Bar), or at least 310 PSI (21.4 Bar). In some embodiments, the compressor train 202 is configured to provide the high-pressure steam 140 to an existing steam header of a facility 102 at a pressure of at most 50 PSI (3.44 Bar), at most 70 PSI (4.83 Bar), at most 90 PSI (6.21 Bar), at most 110 PSI (7.58 Bar), at most 130 PSI (8.96 Bar), at most 150 PSI (10.3 Bar), 170 PSI (11.7 Bar), at most 190 PSI (13.1 Bar), at most 210 PSI (14.5 Bar), at most 230 PSI (15.6 Bar), at most 250 PSI (17.2 Bar), at most 270 PSI (18.6 Bar), at most 290 PSI (20.0 Bar), or at most 310 PSI (21.4 Bar). Accordingly, the system 104 is capable of providing high-pressure steam 140 to the facility 102 at a pressure sufficient such that the high-pressure steam 140 can be directly utilized by the facility 102. In some embodiments, all pressures in this paragraph are quotes as gauge pressures. In some embodiments, all pressures in the present disclosure are gauge pressures, unless expressly stated otherwise.

The system 104 further includes the flash vessel train (e.g., flash vessel train 210 of any of FIGS. 2A-5B, etc.). The flash vessel train 210 includes a series of at least two flash vessels (e.g., first flash vessel 212-1 of any of FIGS. 2A-5B, second flash vessel 212-2 of any of FIGS. 2A-5B, . . . , flash vessel 212-n of FIG. 5B, etc.). For instance, in some embodiments, the flash vessel train 210 includes between two and twenty flash vessels 212, between two and seventeen flash vessels 212, between two and fifteen flash vessels 212, between two and twelve flash vessels 212, between two and nine flash vessels 212, between two and six 204, between two and three flash vessels 212, between three and twenty flash vessels 212, between three and seventeen flash vessels 212, between three and fifteen flash vessels 212, between three and twelve flash vessels 212, between three and nine flash vessels 212, between three and six flash vessels 212, between five and twenty flash vessels 212, between five and seventeen flash vessels 212, between five and fifteen flash vessels 212, between five and twelve flash vessels 212, between five and nine flash vessels 212, between five and six flash vessels 212, between seven and twenty flash vessels 212, between seven and seventeen flash vessels 212, between seven and fifteen flash vessels 212, between seven and twelve flash vessels 212, between seven and nine flash vessels 212, between nine and twenty flash vessels 212, between nine and seventeen flash vessels 212, between nine and fifteen flash vessels 212, between nine and twelve flash vessels 212, between eleven and twenty flash vessels 212, between eleven and seventeen flash vessels 212, between eleven and fifteen flash vessels 212, between eleven and twelve flash vessels 212, between thirteen and twenty flash vessels 212, between thirteen and seventeen flash vessels 212, between thirteen and fifteen flash vessels 212, between fifteen and twenty flash vessels 212, between fifteen and seventeen flash vessels 212, or between seventeen and twenty flash vessels 212, inclusive. In some embodiments, the flash vessel train 210 includes at least two flash vessels 212, at least three flash vessels 212, at least four flash vessels 212, at least five flash vessels 212, at least six flash vessels 212, at least seven flash vessels 212, at least eight flash vessels 212, at least nine flash vessels 212, at least ten flash vessels 212, at least eleven flash vessels 212, at least twelve flash vessels 212, at least thirteen flash vessels 212, at least fourteen flash vessels 212, at least fifteen flash vessels 212, at least sixteen flash vessels 212, at least seventeen flash vessels 212, at least eighteen flash vessels 212, at least nineteen flash vessels 212, or at least twenty flash vessels 212. In some embodiments, the flash vessel train 210 includes at most two flash vessels 212, at most three flash vessels 212, at most four flash vessels 212, at most five flash vessels 212, at most six flash vessels 212, at most seven flash vessels 212, at most eight flash vessels 212, at most nine flash vessels 212, at most ten flash vessels 212, at most eleven flash vessels 212, at most twelve flash vessels 212, at most thirteen flash vessels 212, at most fourteen flash vessels 212, at most fifteen flash vessels 212, at most sixteen flash vessels 212, at most seventeen flash vessels 212, at most eighteen flash vessels 212, at most nineteen flash vessels 212, or at most twenty flash vessels 212. However, the present disclosure is not limited thereto. For instance, referring briefly to FIG. 5C, in some embodiments, the flash vessel train 210 includes one flash vessel 212, which is terminal flash vessel 212. In some embodiments, the flash vessel train 210 consists of one flash vessel 212.

In some embodiments, each compressor 204 in the compressor train 202 and each flash vessel 212 in the flash vessel train 210 share a one-to-one relationship. For instance, referring briefly to FIG. 2A, the system 104 depicts the one-to-one relationship for each compressor 204 in the compressor train 202 and each flash vessel 212 in the flash vessel train 210, in that the compressor train 202 has two compressors 204 and the flash vessel train 210 similarly has two flash vessels 212. In some embodiments, the compressors 204 and flash vessels 212 share the one-to-one relationship when a temperature difference between a first compressor and a second compressor satisfies a threshold temperature, such as 10° C., 20° C., etc. In some embodiments, the compressors 204 and flash vessels 212 share the one-to-one relationship when a temperature difference between a first flash vessel and a second flash vessel satisfies a threshold temperature, such as 20° C. Accordingly, in some embodiments, the compressor train 202 includes p compressors (e.g., first compressor 204-1, second compressor 204-2, . . . , compressor p 204-p) and the flash vessel train 210 includes p flash vessels 212 (e.g., first flash vessel 212-1, second flash vessel 212-2, . . . , flash vessel p 212-p), in which p is an integer that is (i) greater than or equal to two and (ii) less than or equal to twenty. In some embodiments, p is an integer that is (i) greater than two and (ii) less than or equal to twenty. However, the present disclosure is not limited thereto. In some embodiments, each compressor 204 in the compressor train 202 and each flash vessel 212 in the flash vessel train 210 share a many-to-one relationship. As another non-limiting example, referring briefly to FIG. 4, the system 104 depicts the many-to-one relationship for each compressor 204 in the compressor train 202 and each flash vessel 212 in the flash vessel train 210, in that the compressor train 202 has three compressors 204 and the flash vessel train 210 two flash vessels 212. For instance, in some embodiments, when a first size of a first compressor 204 is the same as the second size of a second compressor 204, then a first flash vessel 212 is disposed interposing between the first and second compressors 204, which creates a many-to-one relationship. Accordingly, in some such embodiments, the compressor train 202 includes m compressors 204 (e.g., first compressor 204-1, second compressor 204-2, . . . , compressor m 204-m) and the flash vessel train 210 includes n flash vessels 212 (e.g., first flash vessel 212-1, second flash vessel 212-2, . . . , flash vessel n 212-n), in which m and n are each an integer that is (i) greater than or equal to two and (ii) less than or equal to twenty, and m is greater than n.

Similar to the series of at least two compressors 204 of the compressor train 202, the series of at least two flash vessels 212 of the flash vessel train 210 are coupled, at least in part, fluidically in series, which allows for a stream of medium to flow from one flash vessels 212 in the series of at least two flash vessels 212 into another flash vessel 212 in the series of at least two flash vessels. For instance, in some embodiments, referring briefly to FIG. 2A, the series of at least two flash vessels 212 includes a pathline through both a second inlet a 224-2 of a second flash vessel 212-2, a second liquid outlet 228-2 of the second flash vessel, and a first inlet 224-1 of a first flash vessel 212-1 of the flash vessel train 210 when the series of at least two flash vessels 212 are coupled, at least in part, fluidically in series.

Accordingly, the series of at least two flash vessels 212 includes a terminal flash vessel 212 at one end of the flash vessel train 210. For instance, referring briefly to FIG. 2A, a first flash vessel 212-1 is a first terminal flash vessel 212 of the series of at least two flash vessels 212 at one end of the flash vessel train 210 and a second flash vessel 212-2 is a second terminal flash vessel 212 of the series of at least two flash vessels 212 at a second end of the flash vessel train 210. As another non-limiting example, referring briefly to FIG. 5A, the first flash vessel 212-1 is the first terminal flash vessel 212 of the series of at least two flash vessels 212 at one end of the flash vessel train 210 and a flash vessel 212-n is a second terminal flash vessel 212 of the series of at least two flash vessels 212 at the second end of the flash vessel train 210. Accordingly, by having the at least two flash vessels 212 in fluidic series, the flash vessel train 210 is able to utilize thermal energy from steam condensate (e.g., steam condensate return 214 of any of FIGS. 2A-5B, etc.). However, the present disclosure is not limited thereto.

In some embodiments, each flash vessel 212 in the series of at least two flash vessels 212 is configured to be maintained (e.g., by control module 906 of FIG. 9) at a predetermined internal pressure or predetermined internal pressure range that is less than a saturation pressure of the hot water received by the system 104. For instance, in some embodiments, each flash vessel 212 is configured to be maintained at an internal pressure that is less than a saturation pressure of a hot water received from the inlet 224 into the respective flash vessel 212. Moreover, each flash vessel 212 in the series of at least two flash vessels 212 is configured to expand the hot water that is received by the inlet 224 of the flash vessel 212 to produce low-pressure steam (e.g., first low-pressure steam 206-1 produced by first flash vessel 212-1 of any of FIGS. 2A-5B, second low-pressure steam 206-2 produced by second flash vessel 212-2 of FIG. 2A of any of FIGS. 2A-5B, . . . , low-pressure steam n 206-n produced by flash vessel n 212-n, etc.). For instance, in some embodiments, the internal pressure of a respective flash vessel 212 of the flash vessel train 210 is determined based on the first temperature of the hot water received by the system 104 or a second temperature of condensate (e.g., steam condensate return 214 of FIG. 4, vapor outlet 228-2 of FIG. 2A, etc.) received by the respective flash vessel 212. As a non-limiting example, in some embodiments, the hot water source 110 provides hot water having a temperature of 120° F., then a terminal flash vessel 212-1 in the flash vessel train 210 is configured to have an internal pressure of about 88 milliBar absolute (mBara), which is the saturation pressure of water at 110° F. However, the present disclosure is not limited thereto. In some embodiments, the internal pressure of the respective flash vessel 212 is less than a saturation temperature of a medium received by the flash vessel, such as liquid received from a liquid outlet 228 of a neighboring flash vessel 212 or the hot water received from the hot water source 110. Accordingly, by each flash vessel 212 in the series of at least two flash vessels 212 configured to be maintained at the predetermined internal pressure or predetermined internal pressure range that is less than the saturation pressure of the hot water received by the system 104, the system 104 is capable of not only connecting to a variety of facilities 303 that have different hot water source 110 temperatures, but also adapting in real to operational parameter 916 changes at a respective facility 102 connected to the system 104.

In some embodiments, one or more flash vessels 212 in the flash vessel train 210 is disposed above an inlet (e.g., second inlet 224-2 of any of FIGS. 2A-5B, etc.) of the flash vessel train 210, such that each flash vessel 212 in the one or more flash vessels 212 is elevated, or substantially elevated, from the inlet 224-2 of the flash vessel train 210, which effectively raises a potential energy of each flash vessel 212 in the one or more flash vessels 212. By disposing the one or more flash vessels 212 in the flash vessel train 210 above the inlet 224-2 of the flash vessel train 210, the system 104 is configured to utilize the additional potential energy gained from the pressure difference in heights of the inlet 224-2 of the flash vessel train 210 and the one or more flash vessels 212 in the flash vessel train 210. Moreover, such a configuration allows for the system 104 to have minimal power consumption (e.g., electrical power consumed by power supply 986 of FIG. 9 required to operate repressurization pump 220 of FIG. 2A) when receiving the cooled water produced by each flash vessel 212 in the one or more flash vessels 212 of the flash vessel train 210.

Accordingly, in some embodiments, each flash vessel 212 in the series of at least two flash vessels 212 includes two or more outlets. For instance, in some embodiments, a vapor outlet (e.g., vapor outlet 226-1 of flash vessel 212-1 of any of FIGS. 2A-5B, vapor outlet 226-2 of flash vessel 212-2 of any of FIGS. 2A-5B, . . . , vapor outlet 226-n of flash vessel 212-n of FIG. 5A, etc.) that is configured to convey the low-pressure steam 206 produced by the flash vessel 212 to a compressor 204 of the compressor train 202. For instance, in some embodiments, a first vapor outlet 226-1 of the terminal flash vessel 212-1 is fluidly coupled to the inlet 216-1 of the compressor train 202.

Additionally, the system 104 includes vapor outlets 226 of a remainder of the series of at least two flash vessels 212 that are fluidly coupled between compressors 204 of the series of at least two compressors 204 of the compressor train 202. As a non-limiting example, referring briefly to FIGS. 2A and 4, a second vapor outlet 226-2 of the second flash vessel 212-2 is fluidly coupled to a second inlet 216-2 of a second compressor 204-2 the compressor train 202. As yet another non-limiting example, referring briefly to FIG. 3, the second vapor outlet 226-2 of the second flash vessel 212-2 is fluidly coupled to a third inlet 216-3 of a third compressor 204-3 the compressor train 202.

In some embodiments, the flash vessel train 210 further includes an inlet (e.g., second inlet 224-2 of first flash vessel 212-1 of FIG. 5A, etc.) of the flash vessel train 210. The inlet 224 of the flash vessel train 210 is configured to receive hot water (e.g., hot water source 110 of any of FIGS. 1-5, etc.) from a facility 102. For instance, in some embodiments, the inlet 224 of the flash vessel train 210 is configured to receive hot water received from hot water source 110 from the same facility 102 (e.g., first facility 102-1 of FIG. 1B) that the system 104 provides high-pressure steam 140 to or receives the hot water received from hot water source 110 from a different facility 102 (e.g., second facility 102-2 of FIG. 1A). In some embodiments, the different facility 102 that provides the hot water received from hot water source 110 is unassociated with the utilization of the high-pressure steam 140 produced by the system 104. However, the present disclosure is not limited thereto. Furthermore, in some such embodiments, by utilizing hot water as a medium flowing through the system 104 (e.g., as a refrigerant of the system 104), the efficiency of the system 104 is improved since water has zero global warming potential (0 GWP), is non-flammable, and is non-toxic with no regulatory risk, as opposed to other conventional refrigerants such as hydrofluorocarbons (HFCs) and/or hydrofluoroolefins (HFOs), which are toxic and/or flammable.

In some embodiments, the inlet 224 of the flash vessel train 210 is an inlet of the terminal flash vessel 212-1 of the flash vessel train 210. For instance, in some embodiments, a second inlet 224-2 of the terminal flash vessel 212-1 is configured to receive hot water received from hot water source 110, which is supplied to an interior of the terminal flash vessel 212-1.

In some embodiments, the remainder of the series of at least two flash vessels 212 each includes a liquid outlet (e.g., second liquid outlet 228-2 of any of FIGS. 2-5, etc.). Each liquid outlet 228 of each of the remainder of the series of at least two flash vessels 212 is fluidly coupled to an inlet 224 of another one of the series of at least two flash vessels 212. As a non-limiting example, referring briefly to FIG. 2A, a second flash vessel 212-2 is of the remainder of the series of at least two flash vessels 212 since the second flash vessel 212 is not the terminal flash vessel 212-1 of the flash vessel chain 210, and the second flash vessel 212-2 includes a second liquid outlet 228-2 that is fluidically coupled to an inlet 224-1 of the terminal flash vessel 212-1 of the series of at least two flash vessels 212.

In some embodiments, the terminal flash vessel 212-1 includes a liquid outlet (e.g., first liquid outlet 228-1 of any of FIGS. 2-5, etc.) that is fluidly coupled to an outlet of the system 104. As a non-limiting example, in some embodiments, the outlet of the system 104 is a cooling water source (e.g., cooling water source 120 of any of FIGS. 1-7, etc.) associated with a first facility 102-1 that receives the high-pressure steam 140 produced by the system 104 or a second facility 102-2 associated with hot water received from hot water source 110 by the system 104. For instance, in some embodiments, the outlet for cooling water source 120 of the system 104 is fluidically coupled to the hot water of the hot water source 110 received from the facility 102 or the different facility 102. In this way, in some such embodiments, the outlet for cooling water source 120 of the system 104 is configured as a cooling water source for a closed-loop cooling water process associated with the facility that provides the hot water source 110. Furthermore, in some embodiments, by having the system 104 connect with only the existing steam header and the cooling water source 120 of the same facility 102, the system 104 does not require substantial modification in order to perform under the unique operating conditions of a respective facility 102.

In some embodiments, the liquid outlet 228-1 of the terminal flash vessel 212-1 is fluidly coupled to a repressurization pump (e.g., repressurization pump 220 of any of FIGS. 2-5, etc.). The repressurization pump 220 is coupled to the outlet for cooling water source 120 of the system 104 interposing between the liquid outlet 228 of the terminal flash vessel 212-1, which allows for the repressurization pump 220 to deliver fluid produced by the terminal flash vessel 212-1 to the outlet for cooling water source 120 when a pressure gradient exists between a pressure of the fluid produced by the terminal flash vessel 212-1 and the outlet for cooling water source 120 of the system 104. For instance, in some embodiments, the repressurization pump 220 is configured to produce a negative pressure gradient in order to receive the cooled water produced by the flash vessel 212 from the liquid outlet 228 of the flash vessel 212, such as in order to maintain a steady state of the flash vessel 212. However, the present disclosure is not limited thereto. In some embodiments, the repressurization pump 220 is configured to maintain a pressure of the liquid outlet 228 of the flash vessel 212 at a predetermined pressure or predetermined pressure range.

In some embodiments, the system 104 includes one or more valves (e.g., first valve 218-1 of any of FIGS. 2-5, second valve 218-2 of any of FIGS. 2A-5B, third valve 218-3 of FIG. 5A, fourth valve 218-4 of FIG. 5A, . . . , valve n 218-n of FIG. 5A, etc.), in which each valve 218 in the one or more valves 218 is configured to control (e.g., arrest and/or retard) a flow of medium (e.g., flow rate of hot water received from hot water source 110, flow rate of low-pressure steam 206, flow rate of cooled water etc.) through the valve 218, in which the flow is eventually received by or received from the respective flash vessel 212. In some embodiments, a valve 218 in the one or more valves 218 is disposed upstream from an inlet (e.g., first inlet 224-1 of FIG. 5A, second inlet 224-2 of FIG. 5A, etc.) of respective flash vessel 212 or downstream from an outlet, such as a vapor outlet 226 or a liquid outlet 228 of the respective flash vessel 212. In some embodiments, each valve 218 is configured to meter a flow rate of medium (e.g., flow rate of hot water received from hot water source 110, flow rate of low-pressure steam 206, flow rate of cooled water, etc.) received by or from the respective flash vessel 212.

In some embodiments, the system 104 further includes a controller (e.g., control module 906 of FIG. 9, etc.). In some embodiments, the controller 906 is configured to maintain a temperature range of the flash vessel train 210, such as maintaining a temperature of the high-pressure steam 140 that is produced by the system 104 and/or a temperature of the outlet of the system 104, such as of the cooling water source 120 associated with the facility 102.

In some embodiments, the controller 906 is configured to maintain a respective centrifugal compressor 204 in the compressor train 202 from stonewalling or surging. For instance, in some embodiments, the controller 906 is configured to determine if a mass flow rate associated with the respective centrifugal compressor 204 in the compressor train 202 satisfies a first threshold mass flow rate that is associated with a stonewall condition for flow within the respective centrifugal compressor 204 and/or a second threshold mass flow rate that is associated with a surge condition for flow within the respective centrifugal compressor 204. However, the present disclosure is not limited thereto. As a non-limiting example, each respective compressor 204 has a minimal mass flow rate that the respective compressor 204 is able to stably operate at, which is the surge condition.

In some embodiments, the system 104 further includes a desuperheater train (e.g., desuperheater train 230 of FIG. 5A, etc.). In some embodiments, the desuperheater train 230 includes at least one desuperheater (e.g., first desuperheaters 232-1, 232-2, . . . , and 232-q of FIG. 5A, etc.). For instance, in some embodiments, the desuperheater train 230 includes between two and twenty desuperheaters 232, between two and seventeen desuperheaters 232, between two and fifteen desuperheaters 232, between two and twelve desuperheaters 232, between two and nine desuperheaters 232, between two and six 204, between two and three desuperheaters 232, between three and twenty desuperheaters 232, between three and seventeen desuperheaters 232, between three and fifteen desuperheaters 232, between three and twelve desuperheaters 232, between three and nine desuperheaters 232, between three and six desuperheaters 232, between five and twenty desuperheaters 232, between five and seventeen desuperheaters 232, between five and fifteen desuperheaters 232, between five and twelve desuperheaters 232, between five and nine desuperheaters 232, between five and six desuperheaters 232, between seven and twenty desuperheaters 232, between seven and seventeen desuperheaters 232, between seven and fifteen desuperheaters 232, between seven and twelve desuperheaters 232, between seven and nine desuperheaters 232, between nine and twenty desuperheaters 232, between nine and seventeen desuperheaters 232, between nine and fifteen desuperheaters 232, between nine and twelve desuperheaters 232, between eleven and twenty desuperheaters 232, between eleven and seventeen desuperheaters 232, between eleven and fifteen desuperheaters 232, between eleven and twelve desuperheaters 232, between thirteen and twenty desuperheaters 232, between thirteen and seventeen desuperheaters 232, between thirteen and fifteen desuperheaters 232, between fifteen and twenty desuperheaters 232, between fifteen and seventeen desuperheaters 232, or between seventeen and twenty desuperheaters 232, inclusive. In some embodiments, the compressor train 202 includes at least two desuperheaters 232, at least three desuperheaters 232, at least four desuperheaters 232, at least five desuperheaters 232, at least six desuperheaters 232, at least seven desuperheaters 232, at least eight desuperheaters 232, at least nine desuperheaters 232, at least ten desuperheaters 232, at least eleven desuperheaters 232, at least twelve desuperheaters 232, at least thirteen desuperheaters 232, at least fourteen desuperheaters 232, at least fifteen desuperheaters 232, at least sixteen desuperheaters 232, at least seventeen desuperheaters 232, at least eighteen desuperheaters 232, at least nineteen desuperheaters 232, or at least twenty desuperheaters 232. In some embodiments, the compressor train 202 includes at most two desuperheaters 232, at most three desuperheaters 232, at most four desuperheaters 232, at most five desuperheaters 232, at most six desuperheaters 232, at most seven desuperheaters 232, at most eight desuperheaters 232, at most nine desuperheaters 232, at most ten desuperheaters 232, at most eleven desuperheaters 232, at most twelve desuperheaters 232, at most thirteen desuperheaters 232, at most fourteen desuperheaters 232, at most fifteen desuperheaters 232, at most sixteen desuperheaters 232, at most seventeen desuperheaters 232, at most eighteen desuperheaters 232, at most nineteen desuperheaters 232, or at most twenty desuperheaters 232.

Each desuperheater 232 in the desuperheater train 230 includes an outlet that is configured to inject hot water received from the facility 102 or a different facility 102 into the compressor train 202. For instance, in some embodiments, each desuperheater 232 in the desuperheater train 230 is configured to receive a portion of the hot water received from hot water source 110 supplied to the inlet 224-2 of the terminal flash vessel 212-1, which allows for the desuperheater train 230 to utilize the same source of the hot water received from hot water source 110. However, the present disclosure is not limited thereto. In some embodiments, each desuperheater 232 of the desuperheater train 230 is configured to remove heat (e.g., superheat) that is added to the low-pressure steam 206 by each compressor 204 of the compressor train 202 by injecting the hot water received from the hot water source 110 into the low-pressure steam 206 between compressors 204. Accordingly, in some such embodiments, the water injected by the desuperheater 232 evaporates, which removes the superheat from the low-pressure steam 206 and increases the mass flow of the low-pressure steam 206 through the system 104. In some embodiments, the desuperheater train 230 is configured such that each compressor 204 of the compressor train 202 does not require an interstage cooler. Moreover, in some embodiments, a high efficiency of the system 104 is enabled by utilizing the desuperheater train 230 to provide desuperheating of low-pressure steam 206 when compressed by the compressor 204, which allows the system 104 to operate at or approximately at to a water saturation line without heat loss that would otherwise be incurred due to intercoolers or entropy loss due from high amounts of superheat.

In some embodiments, each compressor 204 in the compressor train 202 and each desuperheater 232 in the desuperheater train 230 share a one-to-one relationship. For instance, referring briefly to FIG. 5A, the system 104 depicts the one-to-one relationship for each compressor 204 in the compressor train 202 and each desuperheater 232 in the desuperheater train 230, in that the compressor train 202 has four compressors 204 and the desuperheater train 230 similarly has four desuperheaters 232. Accordingly, in some embodiments, the compressor train 202 includes m compressors (e.g., first compressor 204-1, second compressor 204-2, . . . , compressor m 204-m of FIG. 5A) and the desuperheater train 230 includes q desuperheaters 232 (e.g., first desuperheater 232-1, second desuperheater 232-2, . . . , desuperheater q 232-q of FIG. 5A), in which m and q are the same integer that is (i) greater than or equal to two and (ii) less than or equal to twenty. In some embodiments, m and q are the same integer that is (i) greater than two and (ii) less than or equal to twenty. However, the present disclosure is not limited thereto. In some embodiments, each compressor 204 in the compressor train 202 and each desuperheater 232 in the desuperheater train 230 share a many-to-one relationship. Accordingly, in some such embodiments, the compressor train 202 includes m compressors and the desuperheater train 230 includes q desuperheaters 232, in which m and q are each an integer that is (i) greater than or equal to two and (ii) less than or equal to twenty, and m is greater than q. However, the present disclosure is not limited thereto.

In some embodiments, the system 104 includes a coefficient of performance (COP) greater than 65 percent of a corresponding Carnot efficiency, in which the Carnot efficiency represents the highest possible efficiency of heat pump systems operating between a higher temperature source and a lower temperature source. For instance, in some embodiments, the system 104, as a heat pump system 104 operating between two sources of different thermal temperatures (e.g., higher temperature hot water source 110 and lower temperature cooling water source 120, lower temperature hot water source 110 and higher temperature high-pressure steam, higher temperature high-pressure steam and lower temperature cooling water source 120, or a combination thereof) has an associated efficiency rating, which is in determine in accordance with a coefficient of performance (COP), an energy efficiency ratio (EER), or the like. In some embodiments, the COP is determined in accordance with a value of heat transferred from a lower temperature source divided by network input, which is a value of heat transferred to a higher temperature source less a refrigerant effect value. For instance, in some embodiments, the COP of the system 104 is determined in accordance with a temperature of the high-pressure steam 140 produced by the system 104 and a temperature of the hot water source 110 that provides hot water received by the system. In some embodiments, the COP of the system 104 is determined in accordance with a ratio of an electrical power consumption of the system 104 against an output thermal power of the system 104. In some embodiments, the corresponding percentage Carnot efficiency was determined in accordance with a ratio of a Carnot COP against an actual COP of the system 104. Additional details and information regarding the COP and/or Carnot efficiency of a heat pump system is found at Sadegh, et al., 2018, “Marks' Standard Handbook for Mechanical Engineers,” McGraw-Hill Education., print, which is hereby incorporated by reference in its entirety for all purposes.

In some embodiments, a flash vessel 212 in the flash vessel train 210 includes a blowdown (e.g., blowdown 170 of FIG. 1A or 5B, etc.). In some embodiments, the blowdown 170 is configured to remove a contaminant that is accommodated by the flash vessel 212. For instance, in some embodiments, the blowdown 170 is configured to continuously remove the contaminant that is accommodated by the flash vessel 212 (e.g., a continuous blowdown 170) or intermittently remove the contaminant that is accommodated by the flash vessel 212. For instance, in some embodiments, the contaminant includes one or more fluids and/or one or more solids that are removed at least in part from the system 104 by discharging the contaminants via the blowdown 170, which allows downstream components of the system 104 and the flash vessel 212 to remain unimpeded in heat transfer efficiency by the contaminants. In some embodiments, the contaminant is void or substantially void of steam (e.g., low-pressure steam 206, high-pressure steam 140, etc.). In some embodiments, by purging the contaminant via the blowdown 170, the flash vessel 212 is allowed to further receive hot water received from hot water source 110 and, therefore, generate high-pressure steam 140 via the compressor train 202, such as a makeup hot water received from hot water source 110. Moreover, in some embodiments, the blowdown 170 is configured to remove at least in part the contaminants at a temperature below the first temperature of the hot water, which allows for the purging to be completed without resulting heat loss of the system 104. However, the present disclosure is not limited thereto. In some embodiments, the blowdown 170 is configured to continuously remove the contaminant without an active control mechanism (e.g., without receiving one or more instructions from a controller 906). For instance, in some embodiments, the blowdown 170 is in electronic communication with a sensor 982 configured to detect one or more contaminants within the flash vessel 212, such as a conductivity sensor 982, which provides feedback information to the blowdown 170 about a status of the one or more contaminants.

In some embodiments, the blowdown 170 is associated with a second liquid outlet of a corresponding flash vessel 212 in the flash vessel train 210. In some embodiments, the blowdown 170 is fluidly configured to selectively remove fluid from a corresponding flash vessel 212.

In some embodiments, the controller 906 is in electronic communication with the second liquid outlet of the corresponding flash vessel 212. In some embodiments, the controller is configured to control the selective removal of fluid.

In some embodiments, a flash vessel 212 in the flash vessel train 210 includes a deaerator (e.g., deaerator 240 of FIG. 5B). In some embodiments, the deaerator 240 is configured to form an outlet of the flash vessel 212, such as a second liquid outlet of the flash vessel 212. In some embodiments, the deaerator 240 is configured to selectively remove fluid from a corresponding flash vessel 412. For instance, in some embodiments, in accordance with a determination that a threshold quantity of a first medium (e.g., contaminants within the flash vessel, hot water within the flash vessel, steam within the flash vessel, etc.), the deaerator 240 is configured to modify an opening of the outlet of the flash vessel 212, which allows for the selective removal of fluid from the corresponding flash vessel 212. In some such embodiments, the fluid removed from the corresponding flash vessel 212 includes one or more gases (e.g., oxygen, carbon dioxide, etc.) accommodated by the flash vessel 212 and/or one or more liquids accommodated by the flash vessel 212. However, the present disclosure is not limited thereto. In some embodiments, the controller 1906 of the system 104 is in electronic communication with the second liquid outlet associated with the deaerator 240. In some such embodiments, the controller 1906 is configured selectively allow for fluidic communication between the second liquid outlet and the outlet of the system 104, which allows for the removal of the fluid from the flash vessel 212. In some embodiments, in accordance with a determination that a temperature and/or a pressure associated with the compressor train 202 satisfies a threshold pressure and/or temperature, the controller 906 is the controller is configured to modify a flow rate of fluid through the desuperheater 232. As a non-limiting example, in some embodiments, the controller 906 is configured configured to modify a size of the second outlet, such as a diameter of an aperture or opening of the outlet of the desuperheater 232. For instance, in some embodiments, the in accordance with a determination that the pressure associated with the compressor 204 is less than the threshold pressure and, therefore, does not satisfy the threshold pressure, the controller is configured to reduce a size (e.g., diameter of an aperture) of the second outlet in order to increase an internal pressure of the system 104 and/or in order to modify a mass flow rate of fluid outputted by the desuperheater 232. However, the present disclosure is not limited thereto.

In some embodiments, the system 104 further includes one or more boilers (e.g., boiler 236 of FIG. 5A). The boiler 236 is disposed interposing between and fluidly coupled to the outlet 208 of the compressor train 202. In some embodiments, the boiler 236 is configured to remove moisture, or condensate, from the high-pressure steam 140 generated by the compressor train 202. For instance, in some embodiments, the boiler 236 is configured to heat the high-pressure steam, such as in order to create superheated steam. In some embodiments, the boiler 236 is configured to provide supplementary steam to address peak steam demands from the facility 102 that exceed the steam production capability of the compressor train 202. In some embodiments, the boiler 236 is configured to serve as a backup source of steam production for the facility 102 in the event that the compressor train 202 is intentionally or unintentionally powered down. However, the present disclosure is not limited thereto.

In some embodiments, the system 104 further includes a steam accumulator (e.g., steam accumulator 238 of FIG. 5A). The steam accumulator 238 is disposed interposing between and fluidly coupled to the outlet 208 of the compressor train 202. For instance, in some embodiments, the steam accumulator 238 is configured to increase a storage capacity of the system 104, which allows for the system 104 to respond to fluctuations (e.g., one or more peaks and/or one or more valleys) in demand by the facility for the high-pressure steam 140 produced by the system 104.

The systems, methods, and apparatuses of the present disclosure have other features and advantages which will be apparent from or are set forth in more detail in the accompanying drawings, which are incorporated herein, and the following Detailed Description, which together serve to explain certain principles of the present invention.

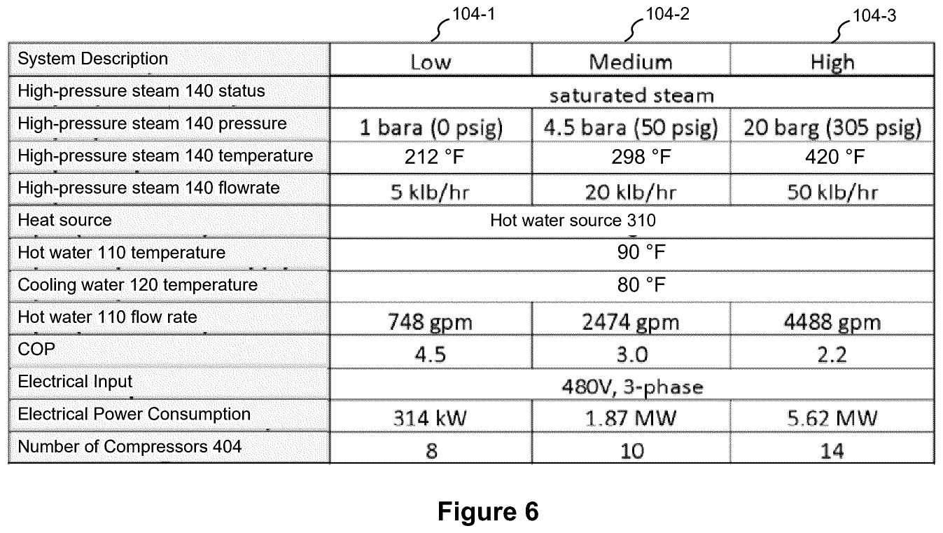

FIG. 6 is a chart diagram depicting various parameters associated with a variety of high-pressure steam production heat pump systems, in accordance with some embodiments. Referring to FIG. 6, in some embodiments, the systems, methods, and apparatuses of the present disclosure provide a plurality of heat pump systems 104. In some embodiments, each heat pump system 104 in the plurality of heat pump systems 104 is configured to achieve a unique set of parameter requirements. In some embodiments, a unique set of parameter (e.g., parameters 916 of FIG. 9) requirements included an output pressure of high-pressure steam generated by a respective system 104, an output flow rate of high-pressure steam generated by the respective system 104, and a temperature of the hot water source 110 received by the respective system 104. In some embodiments, the remainder of the parameters 916 are either held constant across each heat pump system 104 or are derived directly from the unique set of parameter 916 associated with the respective system 104.

Furthermore, the systems, methods, and apparatuses of the present disclosure avoid an intermediate refrigerant and associated losses transferring heat to and/or from the intermediate refrigerant. Rather, the systems, methods, and apparatuses of the present disclosure generated high-pressure steam directly from the hot water source 110 and directly compressed with low-pressure steam generated by a flash vessel train 210 using a multi-stage mechanical vapor recompression (MVR) compressor train 202 having a series of at least two centrifugal compressors 204. In some embodiments, the system 104 included a desuperheater train 230 including a desuperheater 232 disposed between each compressor 204 of the compressor train 202.

Accordingly, in some embodiments, the systems, methods, and apparatuses of the present disclosure achieved high COP (e.g., a COP of 4.5, a COP of 4.0, etc.) by leveraging high efficiency associated with utilizing one or more centrifugal compressors 204 in the compressor train 202 and avoiding superheat losses associated with high compression ratio compressors 204 typically found in conventional high-temperature industrial heat pumps technology.

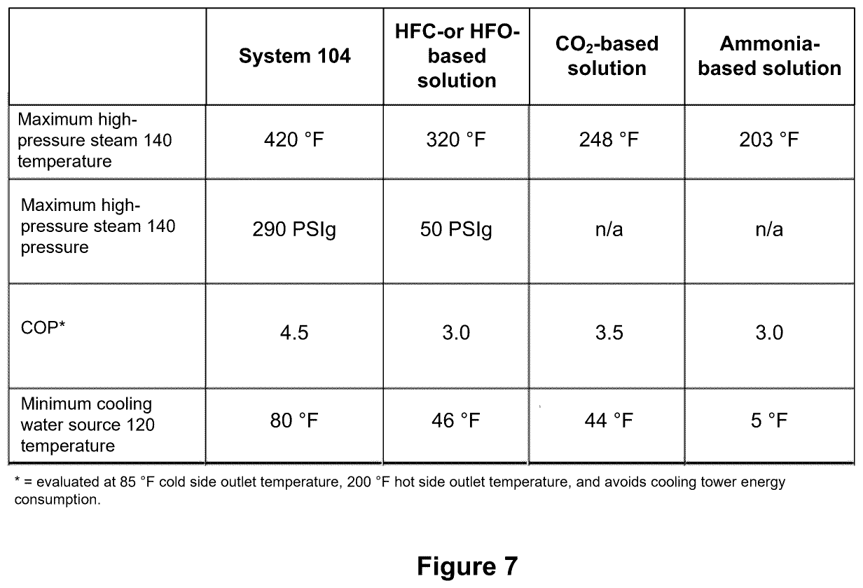

FIG. 7 is a chart diagram depicting performance of high-pressure steam production heat pump system in comparison against a variety of conventional technologies, in accordance with some embodiments. In some embodiments, a heat pump system 104 of the systems, methods, and apparatuses of the present disclosure was utilized to produce high-pressure steam 140 as a comparison against a conventional high-temperature industrial heat pump technology. The heat pump system 104 performs better than conventional high-temperature industrial heat pumps.

In some embodiments, primary competitive advantages of the systems, methods, and apparatuses of the present disclosure over conventional high-temperature industrial heat pump technology were the ability to produce steam at a higher pressure, produce the high-pressure steam with a higher coefficient of performance, use a more attractive refrigerant in the form of water, or a combination thereof.

In some embodiments, conventional high-temperature industrial heat pump technology using one or more hydrofluorocarbons (HFC) refrigerants and/or one or more hydrofluoroolefins (HFO) refrigerants that produced thermal energy at temperatures up to 320 degrees Fahrenheit (160° C.). In some embodiments, the conventional high-temperature industrial heat pump was unable to produce steam directly, but rather must be used in combination with an unfired steam generator, which introduces a 20° F. nominal temperature drop. As a result, the maximum saturated steam pressure the conventional high-temperature industrial heat pump can produce was 3.5 Barg (50 PSIg), which was not sufficient to address medium pressure (e.g., between 3.5 Barg and 20 Barg) applications common to industrial facilities 102. In addition, the conventional high-temperature industrial heat pump had a relatively low coefficient of performance of that is less than 3.0, resulting in high electricity demand and high operating costs.

Furthermore, the one or more HFC refrigerants have high global warming potential (GWP). In contrast, the one or more HFO refrigerants have low GWP but prohibitive cost. In contrast, the heat pump system 104 of the systems, methods, and apparatuses of the present disclosure directly produced high-pressure steam 140 at pressures up to 20 Barg (290 PSIg). Moreover, the heat pump system 104 of the systems, methods, and apparatuses of the present disclosure produced this high-pressure steam 140 with a COP that is 50% higher than the conventional high-temperature industrial heat pump when performing under the same operating conditions, which resulted in proportionally lower electric demand and operating costs for the heat pump system 104 of the systems, methods, and apparatuses of the present disclosure. Moreover, since the heat pump system 104 of the systems, methods, and apparatuses of the present disclosure used water as a refrigerant, the heat pump system 104 provided the benefits of being low-cost, safe, non-toxic, zero-GWP, or a combination thereof.

Moreover, conventional high-temperature industrial heat pump that were CO₂-based utilized a low-cost and low-GWP refrigerant in the form of CO₂. However, the conventional high-temperature industrial CO₂ heat pump was limited to temperatures of 238° F. (114° C.) or less due to the high pressures required by the refrigerant. In this way, one of skill in the art will appreciate that, although 238° F. (114° C.) is above the atmospheric boiling point of water, the conventional high-temperature industrial CO₂-based heat pump was not able to generate adequate high-pressure steam because the conventional high-temperature industrial CO₂-based heat pump required a low fluid return temperature of 203° F. (95° C.) or less, which directly dictated an ability of the conventional high-temperature industrial CO₂-based heat pump to drive a steam generator.

Furthermore, conventional high-temperature industrial heat pump that were ammonia-based heat pump have the high-pressure characteristics that limited the conventional high-temperature industrial ammonia-based heat pump to a maximum output temperature of 203° F. (95° C.), which was unsuitable for steam generation.

Referring to FIG. 7, in some embodiments, a heat pump system 104 of the systems, methods, and apparatuses of the present disclosure was utilized to produce high-pressure steam 140 as a comparison against a conventional boiler technology, such as conventional electric boiler technology and/or conventional natural gas boiler technology. A heat pump system 104 performs better against conventional boilers.

In some embodiments, primary competitive advantages of the systems, methods, and apparatuses of the present disclosure over conventional electric boiler technology was a higher COP by the of the systems, methods, and apparatuses of the present disclosure, which led to lower operating costs. Furthermore, the conventional electric boiler technologies were determined to have a COP approaching 1.0 and required approximately 295 kilowatt hours (kWh) of electricity to produce 1 klb of steam. When the price of an industrial electricity was assumed to be 0.12 dollars ($) per kWh, the conventional electric boiler required $35.40 in energy costs per klb of steam generated by the conventional electric boiler technology.

In contrast, even though the COP of the systems, methods, and apparatuses of the present disclosure depended on the temperature of the hot water source 110 received by the system 104, the temperature of cooling water source 120 associated with the system 104, and a common operating condition that sourced 85° F. hot water from the facility and produced 10 Barg (130 PSIg) high-pressure steam 140. At these operating conditions, the systems, methods, and apparatuses of the present disclosure had a COP of 3.0. Moreover, the systems, methods, and apparatuses of the present disclosure required three times less electricity than the conventional electric boiler of 97 kWh per klb of high-pressure steam. Additionally, the systems, methods, and apparatuses of the present disclosure provided three times lower energy cost than the conventional electric boiler, at a cost of $11.80 per klb of high-pressure steam.

Furthermore, the operating costs of the systems, methods, and apparatuses of the present disclosure were comparable or lower than the conventional natural gas boiler technologies. For instance, new conventional natural gas boiler technologies with economizers have a COP of 0.85 and required approximately 11.8 therms (thm) of natural gas to produce 1 klb of high-pressure steam. At a natural gas price of $1.30 per thm, conventional natural gas boiler technologies require $15.34 of energy costs per klb of steam, which is greater than the $11.80/klb achieved by the systems, methods, and apparatuses of the present disclosure.

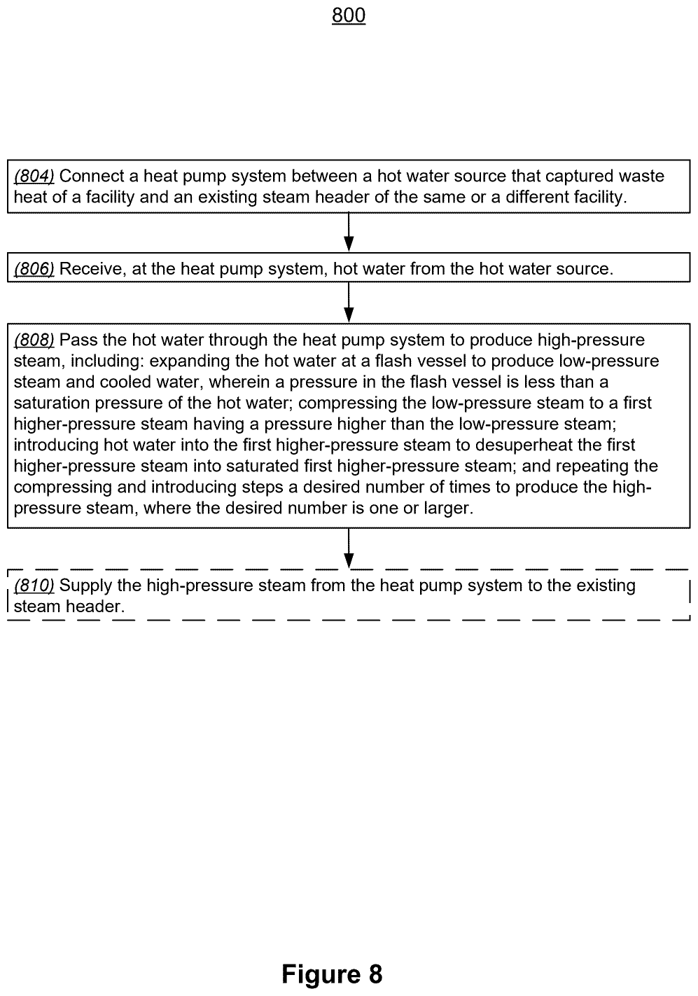

FIG. 8 is a flow chart of an example method (e.g., method 800) for producing high-pressure steam, in which dashed boxes represent optional elements in the flow chart, in accordance with some embodiments. Specifically, the method 800 is applied for producing a high-pressure steam (e.g., high-pressure steam 140-1 or 140-2 of FIG. 1A, high-pressure steam 140 of any of FIGS. 1-7, etc.). Various modules in the memory 992 of the computer system 900 perform certain processes of the methods 200 described in FIGS. 2, unless expressly stated otherwise. Furthermore, it will be appreciated that the processes in FIG. 8 can be encoded in a single module or any combination of modules.

In some embodiments, the method 800 is conducted by a heat pump system 104 in FIGS. 1-7. In some embodiments, the method 800 is conducted at, or in conjunction with, a computer system (e.g., computer system 900 of FIG. 9, etc.). The computer system 900 includes one or more processors (e.g., CPU 972 of FIG. 9), and a memory (e.g., memory 992 of FIG. 9) that is coupled to the one or more processors 172. The memory 992 includes one or more programs (e.g., control module 906 of FIG. 9, client application 918 of FIG. 9, etc.) that is configured to be executed by the one or more processors 972. In other words, in some embodiments, the method 800 cannot be mentally performed because the computational complexity addressed by the method 800 requires use of the computer system 900.

Referring to block 804 in FIG. 8, the method 800 includes coupling a heat pump system (e.g., system 104 of any of FIGS. 1A-7, etc.) to one or more facilities (e.g., first facility 102-1 of FIG. 1A, second facility 102-2 of FIG. 1A, etc.). In some situations, the heat pump system is connected to the one or more facilities. In some embodiments, each facility 102 is associated with an industrial process, such as a chemical process, a pulp process, a paper process, a metallurgy process, a refinery process, a lumber drying process, a packaging process, or a combination thereof. One of skill in art will appreciate that other industrial processes exist within the domain of the facility 102 of the present disclosure. Accordingly, the method 800 allows for connecting the heat pump system 104 to the one or more facilities 102 in order to provide energy requirements for the one or more facilities 102.

In some embodiments, the heat pump system 104 is connected to a hot water source (e.g., hot water source 110 of any of FIGS. 1, 5, and 6, etc.). In some embodiments, the hot water source 110 is configured to capture waste heat of a first facility 102-1, which allows the heat pump system 104 to utilize this waste heat via a heat transfer process. As a non-limiting example, in some embodiments, the hot water source 110 includes boiler feedwater (e.g., boiler feedwater 160 of FIG. 1A), which has a high-temperature with excess heat to be captured by the system 104. For instance, in some embodiments, the hot water source 110 includes a stream of cooling water return from a cooling process conducted at the facility 102 and/or a stream of makeup water produced at the facility 102. In some embodiments, the stream of cooling water return from the cooling process conducted at the facility 102 and/or the stream of makeup water produced at the facility 102 merge prior to being received by the system 104. However, the present disclosure is not limited thereto. In some embodiments, additional hot water (e.g., boiler feedwater) is received by the system 104, such as in order to maintain a constant water volume in the system 104. However, the present disclosure is not limited thereto. Accordingly, the hot water source 110 provides a low-grade heat source in the form of the hot water that is received by the system 104, which has energy in the form of heat that the facility 102 would otherwise reject (e.g., reject heat to the atmosphere via a cooling tower process and/or to waste water). Moreover, in some embodiments, the heat pump system 104 is further connected and an existing steam header of the same facility 102 (e.g., first facility 102-1 of FIG. 1A) or a different facility 102 (e.g., second facility 102-2 of FIG. 1A), which allows for the heat pump system 104 to have a one-to-one relationship with a facility 102 or a one-to-many relationship with two or more facilities 102. For instance, in some embodiments, the heat pump system 104 is connected between the hot water source 110, which is configured to capture waste heat of the first facility 102-1, and the existing steam header of the first facility 102-1, which allows the heat pump system 104 to produce high-pressure steam 140 that is then utilized at the first facility 102-1, which is received from the hot water source 110 that captured waste heat of the first facility 102-1. As another non-limiting example, in some embodiments, the heat pump system 104 is connected between the hot water source 110, which is configured to capture waste heat of the first facility 102-1, and the existing steam header of the second facility 102-2, which allows the heat pump system 104 to produce high-pressure steam 140 that can be utilized at the second facility 102-2, which is received from the hot water source 110 that captured waste heat of the first facility 102-1. Accordingly, by having the heat pump system 104 connect between the hot water source 110 of the facility 102 and the existing steam header of the same or a different facility 102, the method 800 provides for optimizing the efficiency of the heat pump system 104 without needing to modify or substantially modify existing structures, such as the existing steam header, of the same or the different facility 102 connected to the heat pump system 104. In this way, the heat pump system 104 allows for standardizing connections between the hot water source 110 of the facility 102 and the existing steam header of the same or the different facility 102.

Furthermore, in some embodiments, the heat pump system 104 is connected to a steam condensate return (e.g., steam condensate return 214 of any of FIGS. 2-5, etc.). For instance, in some embodiments, the heat pump system 104 is connected between the steam condensate return 214, which is configured to capture waste condensate from the existing steam header of the first facility 102-1, which allows the heat pump system 104 to produce high-pressure steam 140 by recycling the steam condensate return 214 that is otherwise rejected by the first facility 102-1. In some embodiments, the heat pump system 104 is connected between steam condensate return 214, which is configured to capture waste condensate from a second facility 102-2 different from the first facility 102-1. However, the present disclosure is not limited thereto.

In some embodiments, the connecting the heat pump system 104 between the hot water source 110 of the facility 102 and the existing steam header of the same or the different facility 102 further connects the heat pump system 104 to one or more utilities of the facility 102. For instance, referring briefly to FIG. 9, in some embodiments, the heat pump system 104 is further connected to a power supply (e.g., power supply 986 of FIG. 9) of the facility 102, which allows for electric communication between the facility 102 and the heat pump system 104 in order to convey electricity (e.g., electricity 150 of FIG. 1B) for use by the heat pump system 104, such as in order to drive one or more motors of a compressor train (e.g., compressor train 202 of any of FIGS. 2-5, etc.) of the heat pump system 104.

It is noted that in various embodiments of this application, “connect” broadly means “directly connect” or “indirectly connected” via an additional structure.

Referring to block 806 in FIG. 8, the method 800 includes receiving hot water from the hot water source 110 at the heat pump system 104. In some embodiments, the heat pump system 104 is configured to receive the hot water from the hot water source 110 at a first temperature. In some embodiments, the first temperature of the hot water received by the heat pump system 104 is between 60 degrees Fahrenheit (° F.) (15.6 degrees Celsius (° C.)) and 150° F. (65.6° C.). In some embodiments, the first temperature of the hot water received by the heat pump system 104 is between 60° F. (15.6° C.) and 220° F. (104° C.). For instance, in some embodiments, the heat pump system 104 is configured to receive the hot water from the hot water source 110 at the first temperature between 60° F. (15.6° C.) and 220° F. (65.6° C.), between 60° F. (15.6° C.) and 205° F. (96.1° C.), between 60° F. (15.6° C.) and 190° F. (87.8° C.), between 60° F. (15.6° C.) and 175° F. (79.4° C.), between 60° F. (15.6° C.) and 150° F. (65.6° C.), between 60° F. (15.6° C.) and 135° F. (57.2° C.), between 60° F. (15.6° C.) and 120° F. (48.9° C.), between 60° F. (15.6° C.) and 105° F. (40.6° C.), between 60° F. (15.6° C.) and 90° F. (32.2° C.), between 60° F. (15.6° C.) and 75° F. (23.9° F.), between 80° F. (26.7° C.) and 220° F. (65.6° C.), between 80° F. (26.7° C.) and 205° F. (96.1° C.), between 80° F. (26.7° C.) and 190° F. (87.8° C.), between 80° F. (26.7° C.) and 175° F. (79.4° C.), between 80° F. (26.7° C.) and 150° F. (65.6° C.), between 80° F. (26.7° C.) and 135° F. (57.2° C.), between 80° F. (26.7° C.) and 120° F. (48.9° C.), between 80° F. (26.7° C.) and 105° F. (40.6° C.), between 80° F. (26.7° C.) and 90° F. (32.2° C.), between 100° F. (37.8° C.) and 220° F. (65.6° C.), between 100° F. (37.8° C.) and 205° F. (96.1° C.), between 100° F. (37.8° C.) and 190° F. (87.8° C.), between 100° F. (37.8° C.) and 175° F. (79.4° C.), between 100° F. (37.8° C.) and 150° F. (65.6° C.), between 100° F. (37.8° C.) and 135° F. (57.2° C.), between 100° F. (37.8° C.) and 120° F. (48.9° C.), between 100° F. (37.8° C.) and 105° F. (40.6° C.), between 120° F. (48.9° C.) and 220° F. (65.6° C.), between 120° F. (48.9° C.) and 205° F. (96.1° C.), between 120° F. (48.9° C.) and 190° F. (87.8° C.), between 120° F. (48.9° C.) and 175° F. (79.4° C.), between 120° F. (48.9° C.) and 150° F. (65.6° C.), between 120° F. (48.9° C.) and 135° F. (57.2° C.), between 140° F. (60.0° C.) and 220° F. (65.6° C.), between 140° F. (60.0° C.) and 205° F. (96.1° C.), between 140° F. (60.0° C.) and 190° F. (87.8° C.), between 140° F. (60.0° C.) and 175° F. (79.4° C.), between 140° F. (60.0° C.) and 150° F. (65.6° C.), between 175° F. (79.4° C.), and 220° F. (65.6° C.), between 175° F. (79.4° C.), and 205° F. (96.1° C.), between 175° F. (79.4° C.), and 190° F. (87.8° C.), between 190° F. (87.8° C.) and 220° F. (65.6° C.), between 190° F. (87.8° C.) and 205° F. (96.1° C.), or between 205° F. (96.1° C.) and 220° F. (65.6° C.), inclusive. In some embodiments, the first temperature from the hot water source 110 received by the heat pump system 104 is at least 60° F. (15.6° C.), at least 65° F. (18.3° C.), at least 70° F. (21.1° C.), at least 75° F. (23.9° C.), at least 80° F. (26.7° C.), at least 85° F. (29.4° C.), at least 90° F. (32.2° C.), at least 95° F. (35.0° C.), at least 100° F. (37.8° C.), 105° F. (40.6° C.), at least 110° F. (43.3° C.), at least 115° F. (46.1° C.), at least 120° F. (48.9° C.), at least 125° F. (51.7° C.), at least 130° F. (54.4° C.), at least 135° F. (57.2° C.), at least 140° F. (60.0° C.), at least 145° F. (62.8° C.), at least 150° F. (65.6° C.), at least 155° F. (68.3° C.), at least 160° F. (71.1° C.), at least 165° F. (73.9° C.), at least 170° F. (76.7° C.), at least 175° F. (79.4° C.), at least 180° F. (82.2° C.), at least 185° F. (85.0° C.), at least 190° F. (87.8° C.), at least 195° F. (90.6° C.), at least 200° F. (93.3° C.), at least 205° F. (96.1° C.), at least 210° F. (98.9° C.), at least 215° F. (102° C.), or at least 220° F. (104° C.). In some embodiments, the first temperature from the hot water source 110 received by the heat pump system 104 is at most 60° F. (15.6° C.), at most 65° F. (18.3° C.), at most 70° F. (21.1° C.), at most 75° F. (23.9° C.), at most 80° F. (26.7° C.), at most 85° F. (29.4° C.), at most 90° F. (32.2° C.), at most 95° F. (35.0° C.), at most 100° F. (37.8° C.), 105° F. (40.6° C.), at most 110° F. (43.3° C.), at most 115° F. (46.1° C.), at most 120° F. (48.9° C.), at most 125° F. (51.7° C.), at most 130° F. (54.4° C.), at most 135° F. (57.2° C.), at most 140° F. (60.0° C.), at most 145° F. (62.8° C.), at most 150° F. (65.6° C.), at most 155° F. (68.3° C.), at most 160° F. (71.1° C.), at most 165° F. (73.9° C.), at most 170° F. (76.7° C.), at most 175° F. (79.4° C.), at most 180° F. (82.2° C.), at most 185° F. (85.0° C.), at most 190° F. (87.8° C.), at most 195° F. (90.6° C.), at most 200° F. (93.3° C.), at most 205° F. (96.1° C.), at most 210° F. (98.9° C.), at most 215° F. (102° C.), or at most 220° F. (104° C.). For instance, in some embodiments, the hot water source 110 is utilized to receive low-grade heat in the form of hot water that is sourced from existing, commonly-available on-site heat sources such as a cooling water return of a cooling tower process, which is typically at a temperature between 85° F. (29.4° C.) and 90° F. (32.2° C.). In some embodiments, the low-grade heat in the form of hot water is sourced from a dryer exhaust, which is at a temperature between 140° F. (60.0° C.) and 180° F. (82.2° C.). In some embodiments, the system 104 includes a heat exchange mechanism interposing between the hot water source 110 and an inlet of the system 104, which allows for heat of the hot water to transfer to a heat pump water loop of the system 104 via the heat exchange mechanism. For instance, in some embodiments, the heat exchange mechanism is configured to produce condensate (e.g., condensate 180 of FIG. 1A), either at the facility 102 or the system 104. However, the present disclosure is not limited thereto.

In some embodiments, the system 104 further includes a water loop, such as closed water loop configured to. In some embodiments, the water loop includes an upstream portion and a downstream portion. In some embodiments, the downstream portion is configured to receive the hot water from the same or a different facility. In some embodiments, the upstream portion configured to supply cooling water to the same or the different facility. Moreover, in some embodiments, the water loop is heated by the same or the different facility.

Referring to block 808 in FIG. 8, the method 800 includes passing the hot water through the heat pump system 104 to produce high-pressure steam (e.g., high-pressure steam of method 800 of FIG. 8, high-pressure steam 140-1 or 140-2 of FIG. 1B, high-pressure steam 140 of any of FIGS. 1A-7, etc.).

For instance, in some embodiments, the heat pump system 104 includes a compressor train (e.g., compressor train 202 of any of FIGS. 2-5, etc.) and a flash vessel train (e.g., flash vessel 212 of any of FIGS. 2A-5B, etc.), which collectively are utilized by the method 800 to produce the high-pressure steam 140 for the facility 102.

More particularly, in some embodiments, the passing the hot water through the heat pump system 104 to produce the high-pressure steam 140 includes expanding the hot water at a flash vessel (e.g., first flash vessel 212-1 of any of FIGS. 2-5, etc.). By expanding the hot water at the flash vessel 212, the flash vessel 212 produces the low-pressure steam 206 that is further utilized by the compressor train 202. Moreover, in some such embodiments, due to the expansion of the hot water within the flash vessel 212, the low-pressure steam 206 produced by the flash vessel has a lower temperature than the hot water received by the heat pump system 104. Said otherwise, in some such embodiments, a second temperature of a first low-pressure steam 206 produced by the first flash vessel 212-1 is less than the first temperature of the hot water source 110. Moreover, in some such embodiments, the flash vessel 212 operates in a passive, steady state when producing the low-pressure steam 206, which increases an efficiency of the heat pump system 104. However, the present disclosure is not limited thereto.

In some embodiments, the method 800 is configured to produce the first low-pressure steam 206-1 a first pressure between 0.256 pounds per square inch (PSI) (17.7 milliBar (mBar)) and 3.72 PSI (257 mBar), between 0.256 PSI (17.7 mBar) and 3.2 PSI (221 mBar), between 0.256 PSI (17.7 mBar) and 2.7 PSI (186 mBar), between 0.256 PSI (17.7 mBar) and 1.2 PSI (82.7 mBar), between 0.256 PSI (17.7 mBar) and 0.7 PSI (48.3 mBar), between 0.35 PSI (24.1 mBar) and 3.72 PSI (257 mBar), between 0.35 PSI (24.1 mBar) and 3.2 PSI (221 mBar), between 0.35 PSI (24.1 mBar) and 2.7 PSI (186 mBar), between 0.35 PSI (24.1 mBar) and 1.2 PSI (82.7 mBar), between 0.35 PSI (24.1 mBar) and 0.7 PSI (48.3 mBar), between 0.85 PSI (58.6 mBar) and 3.72 PSI (257 mBar), between 0.85 PSI (58.6 mBar) and 3.2 PSI (221 mBar), between 0.85 PSI (58.6 mBar) and 2.7 PSI (186 mBar), between 0.85 PSI (58.6 mBar) and 1.2 PSI (82.7 mBar), between 1.35 PSI (93.1 mBar) and 3.72 PSI (257 mBar), between 1.35 PSI (93.1 mBar) and 3.2 PSI (221 mBar), between 1.35 PSI (93.1 mBar) and 2.7 PSI (186 mBar), between 1.85 PSI (128 mBar) and 3.72 PSI (257 mBar), between 1.85 PSI (128 mBar) and 3.2 PSI (221 mBar), between 1.85 PSI (128 mBar) and 2.7 PSI (186 mBar), between 2.35 PSI (162 mBar) and 3.72 PSI (257 mBar), between 2.35 PSI (162 mBar) and 3.2 PSI (221 mBar), between 2.35 PSI (162 mBar) and 2.7 PSI (186 mBar), between 2.85 PSI (197 mBar) and 3.72 PSI (257 mBar), between 2.85 PSI (197 mBar) and 3.2 PSI (221 mBar), or between 3.35 PSI (231 mBar) and 3.72 PSI (257 mBar), inclusive. In some embodiments, the first pressure is at least 0.256 PSI (17.7 mBar), at least 0.363 PSI (25 mBar), at least 0.35 PSI (24.1 mBar), at least 0.5 PSI (34.5 mBar), at least 0.7 PSI (48.3 mBar), at least 0.85 PSI (58.6 mBar), at least 1 PSI (68.9 mBar), at least 1.2 PSI (82.7 mBar), at least 1.3 PSI (89.6 mBar), at least 1.35 PSI (93.1 mBar), at least 1.5 PSI (103 mBar), at least 1.65 PSI (114 mBar), at least 1.85 PSI (128 mBar), at least 2 PSI (138 mBar), at least 2.2 PSI (152 mBar), at least 2.35 PSI (162 mBar), at least 2.5 PSI (172 mBar), at least 2.7 PSI (186 mBar), at least 2.85 PSI (197 mBar), at least 3 PSI (207 mBar), at least 3.2 PSI (221 mBar), at least 3.35 PSI (231 mBar), at least 3.5 PSI (241 mBar), or at least 3.72 PSI (257 mBar). In some embodiments, the first pressure is at most 0.256 PSI (17.7 mBar), at most 0.363 PSI (25 mBar), at most 0.35 PSI (24.1 mBar), at most 0.5 PSI (34.5 mBar), at most 0.7 PSI (48.3 mBar), at most 0.85 PSI (58.6 mBar), at most 1 PSI (68.9 mBar), at most 1.2 PSI (82.7 mBar), at most 1.3 PSI (89.6 mBar), at most 1.35 PSI (93.1 mBar), at most 1.5 PSI (103 mBar), at most 1.65 PSI (114 mBar), at most 1.85 PSI (128 mBar), at most 2 PSI (138 mBar), at most 2.2 PSI (152 mBar), at most 2.35 PSI (162 mBar), at most 2.5 PSI (172 mBar), at most 2.7 PSI (186 mBar), at most 2.85 PSI (197 mBar), at most 3 PSI (207 mBar), at most 3.2 PSI (221 mBar), at most 3.35 PSI (231 mBar), at most 3.5 PSI (241 mBar), or at most 3.72 PSI (257 mBar).

In some embodiments, the expanding of the hot water at the flash vessel 212 when passing the hot water through the heat pumps system 104 further produces cooled water (e.g., condensate) from the hot water. In some embodiments, the cooled water produced by the flash vessel 212 has a lower temperature than the hot water. Said otherwise, in some such embodiments, a third temperature of the cooled water produced by the flash vessel 212 is less than the first temperature of the first temperature of the hot water source 110. Moreover, in some embodiments, the third temperature of the cooled water is less than the second temperature of the low-pressure steam 206 produced by the flash vessel 212. Accordingly, by expanding the hot water at the flash vessel 212, the heat pump system 104 increases the thermal energy of a portion of the hot water received from the hot water source 110 by forming the low-pressure steam 206, which is transferred from the cooled water produced by the flash vessel 212. For instance, in some embodiments, the facility 102 is configured to utilize the high-pressure steam 140 produced by the system 104, which, in turn, produces the cooling water source 120 at the third temperature that is less than the first temperature of the hot water received from the hot water source 31-0. However, the present disclosure is not limited thereto.

Furthermore, in some embodiments, a pressure in the flash vessel 212 is less than a saturation pressure of the hot water. For instance, in some embodiments, the passing the hot water through the heat pumps system 104 further includes compressing the low-pressure steam 206 to a first higher-pressure steam having a pressure higher than the low-pressure steam. For instance, referring briefly to FIG. 2A, in some embodiments, the first low-pressure steam 206 at the first pressure is further compressed by a second compressor 204-2 that produces the first higher-pressure steam having the pressure higher than the first low-pressure steam, such as second low-pressure steam 206-2 produced by the second compressor 204-2 that has a higher pressure than the first low-pressure steam 206-1 produced by the first compressor 204-1. Accordingly, in some such embodiments, the first higher-pressure steam having the pressure higher than the first low-pressure steam includes the low-pressure steam 206 produced by one or more compressors 204 that is downstream from the first compressor 204-1 that produced the first low-pressure steam 206-1. However, the present disclosure is not limited thereto. For instance, in some embodiments, the first higher-pressure steam having the pressure higher than the first low-pressure steam includes the high-pressure steam 140 that is produced by the heat pump system 104 for utilization by the facility 102.

In some embodiments, the passing the hot water through the heat pumps system 104 further includes introducing hot water into the first higher-pressure steam (e.g., first low-pressure steam 206-1 produced by first flash vessel 212-1 of any of FIGS. 2-5, second low-pressure steam 206-2 produced by second flash vessel 212-2 of any of FIGS. 2-5, . . . , low-pressure steam n 206-n produced by flash vessel n 212-n, etc.). In some embodiments, the hot water is introduced into the first higher-pressure steam in order to desuperheat the first higher-pressure steam into saturated first higher-pressure steam.

In some embodiments, the passing the hot water through the heat pumps system 104 further includes repeating the compressing and introducing steps a desired number of times to produce the high-pressure steam.

In some embodiments, the desired number of times is greater than one. In some embodiments, the desired number of times is greater than one but less than twenty-one. In some embodiments, the desired number of times is between two and twenty, between two and seventeen, between two and fifteen, between two and twelve, between two and nine, between two and six, between two and three, between three and twenty, between three and seventeen, between three and fifteen, between three and twelve, between three and nine, between three and six, between five and twenty, between five and seventeen, between five and fifteen, between five and twelve, between five and nine, between five and six, between seven and twenty, between seven and seventeen, between seven and fifteen, between seven and twelve, between seven and nine, between nine and twenty, between nine and seventeen, between nine and fifteen, between nine and twelve, between eleven and twenty, between eleven and seventeen, between eleven and fifteen, between eleven and twelve, between thirteen and twenty, between thirteen and seventeen, between thirteen and fifteen, between fifteen and twenty, between fifteen and seventeen, or between seventeen and twenty, inclusive. In some embodiments, the desired number of times is at least two, at least three, at least four, at least five, at least six, at least seven, at least eight, at least nine, at least ten, at least eleven, at least twelve, at least thirteen, at least fourteen, at least fifteen, at least sixteen, at least seventeen, at least eighteen, at least nineteen, or at least twenty. In some embodiments, the desired number of times is at most two, at most three, at most four, at most five, at most six, at most seven, at most eight, at most nine, at most ten, at most eleven, at most twelve, at most thirteen, at most fourteen, at most fifteen, at most sixteen, at most seventeen, at most eighteen, at most nineteen, or at most twenty.

Referring to block 810 in FIG. 8, in some embodiments, the method 800 includes supplying the high-pressure steam 140 from the heat pump system 104 to the existing steam header of the same or a different facility 102 that the heat pump system 104 receives hot water from.

In some embodiments, the high-pressure steam 140 is supplied from the heat pump system 104 to the same or a different facility 102 at a mass flow rate between 10 kilopounds per hour (klb/hr) and 300 klb/hr, between 10 klb/hr and 250 klb/hr, between 10 klb/hr and 200 klb/hr, between 10 klb/hr and 150 klb/hr, between 10 klb/hr and 100 klb/hr, between 10 klb/hr and 50 klb/hr, between 75 klb/hr and 300 klb/hr, between 75 klb/hr and 250 klb/hr, between 75 klb/hr and 200 klb/hr, between 75 klb/hr and 150 klb/hr, between 75 klb/hr and 100 klb/hr, between 150 klb/hr and 300 klb/hr, between 150 klb/hr and 250 klb/hr, between 150 klb/hr and 200 klb/hr, between 225 klb/hr and 300 klb/hr, or between 225 klb/hr and 250 klb/hr, inclusive. In some embodiments, the mass flow rate of the high-pressure steam produced by the heat pump system 104 is at least 10 klb/hr, at least 25 klb/hr, at least 50 klb/hr, at least 75 klb/hr, at least 100 klb/hr, at least 125 klb/hr, at least 150 klb/hr, at least 175 klb/hr, at least 200 klb/hr, at least 225 klb/hr, at least 250 klb/hr, at least 275 klb/hr, or at least 300 klb/hr. In some embodiments, the mass flow rate of the high-pressure steam produced by the heat pump system 104 is at most 10 klb/hr, at most 25 klb/hr, at most 50 klb/hr, at most 75 klb/hr, at most 100 klb/hr, at most 125 klb/hr, at most 150 klb/hr, at most 175 klb/hr, at most 200 klb/hr, at most 225 klb/hr, at most 250 klb/hr, at most 275 klb/hr, or at most 300 klb/hr.

In the present disclosure, unless expressly stated otherwise, descriptions of devices and systems will include implementations of one or more computers. For instance, and for purposes of illustration in FIG. 9, a computer system 900 is represented as single device that includes all the functionality of the computer system 900. However, the present disclosure is not limited thereto. For instance, the functionality of the computer system 900 may be spread across any number of networked computers and/or reside on each of several networked computers and/or by hosted on one or more virtual machines and/or containers at a remote location accessible across a communication network (e.g., communication network 984). One of skill in the art will appreciate that a wide array of different computer topologies is possible for the computer system 900, and other devices and systems of the preset disclosure, and that all such topologies are within the scope of the present disclosure. Moreover, rather than relying on a physical communications network 984, the illustrated devices and systems may wirelessly transmit information between each other. As such, the exemplary topology shown in FIG. 9 merely serves to describe the features of some embodiments in a manner that will be readily understood to one of skill in the art.

FIG. 9 is a block diagram illustrating an example computer system 900 that is applied in a high-pressure steam production heat pump system, in accordance with some embodiments. The computer system 900 is configured to control production of high-pressure steam at a heat pump system (e.g., heat pump system 104 of FIGS. 1-7). In some embodiments, the computer system 900 is associated with a facility (e.g., first facility 102-1 of FIG. 3, heat pump system 104 of any of FIGS. 1A-7, second facility 102-2 of FIG. 1A, etc.). In some embodiments, the computer system 900 is associated with two or more facilities 102. In some embodiments, the computer system 900 is associated with at most one facility or at most two or more facilities 102.

In some embodiments, the communication network 984 optionally includes the Internet, one or more local area networks (LANs), one or more wide area networks (WANs), other types of networks, or a combination of such networks. Examples of communication networks 984 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the computer system 900 includes one or more processing units (CPUs) 972, a network or other communications interface 974, and memory 992.

In some embodiments, the computer system 900 includes a user interface 976. The user interface 976 typically includes a display 978 for presenting media, such as a status of a respective instrument (e.g., first instrument 910-1, second instrument 910-2, . . . , instrument Q 912-Q of FIG. 9). In some embodiments, the display 978 is integrated within the computer systems (e.g., housed in the same chassis as the CPU 972 and memory 992). In some embodiments, the computer system 900 includes one or more input device(s) 980, which allow a subject to interact with the computer system 900. In some embodiments, input devices 980 include a keyboard, a mouse, and/or other input mechanisms. Alternatively, or in addition, in some embodiments, the display 978 includes a touch-sensitive surface (e.g., where display 978 is a touch-sensitive display or computer system 900 includes a touch pad).

In some embodiments, the computer system 900 presents media to a user through the display 978. Examples of media presented by the display 978 include one or more images, a video, audio (e.g., waveforms of an audio sample), or a combination thereof. In typical embodiments, the one or more images, the video, the audio, or the combination thereof is presented by the display 978 through a client application stored in the memory 992. In some embodiments, the audio is presented through an external device (e.g., speakers, headphones, input/output (I/O) subsystem, etc.) that receives audio information from the computer system 900 and presents audio data based on this audio information. In some embodiments, the user interface 976 also includes an audio output device, such as speakers or an audio output for connecting with speakers, earphones, or headphones.

The memory 992 includes high-speed random access memory, such as DRAM, SRAM, DDR RAM, or other random access solid state memory devices, and optionally also includes non-volatile memory, such as one or more magnetic disk storage devices, optical disk storage devices, flash memory devices, or other non-volatile solid state storage devices. The memory 992 may optionally include one or more storage devices remotely located from the CPU(s) 972. The memory 992, or alternatively the non-volatile memory device(s) within memory 992, includes a non-transitory computer readable storage medium. Access to memory 992 by other components of the computer system 900, such as the CPU(s) 972, is, optionally, controlled by a controller. In some embodiments, the memory 992 can include mass storage that is remotely located with respect to the CPU(s) 972. In other words, some data stored in the memory 992 may in fact be hosted on devices that are external to the computer system 900, but that can be electronically accessed by the computer system 900 over an Internet, intranet, or other form of network 984 or electronic cable using communication interface 974.

In some embodiments, the memory 992 of the computer system 900 for producing high-pressure steam stores:
an operating system 902 (e.g., ANDROID, iOS, DARWIN, RTXC, LINUX, UNIX, OS X, WINDOWS, or an embedded operating system such as VxWorks) that includes procedures for handling various basic system services;
“optionally, an electronic address 904 associated with the computer system 900 that identifies the computer system 900 (e.g., within the communication network 984, within a network of facilities, etc.);
“a control module 906 that facilitates controlling one or more operations conducted when producing high-pressure steam in accordance with a plurality of heuristic instructions, in which the control module 906 includes an instrument module 908 storing a record of a plurality of instruments 910 (e.g., first instrument 910-1, second instrument 910-2, . . . , instrument 910-Q of FIG. 9) utilized for producing a high-pressure steam, and further includes a task module 912 that stores a plurality of tasks 914, each task 914 defines an operation for producing high-pressure steam at a heat pump system in accordance with one or more parameters 916 associated with a respective task 914; and
“optionally, a client application 918 for presenting information (e.g., media) using a display 978 of the computer system 900, such as a status of a step and/or process of a method (e.g., method 800 of FIG. 8) for producing high-pressure steam.

As indicated above, an optional electronic address 904 is associated with the computer system 900. The optional electronic address 904 is utilized to at least uniquely identify the computer system 900 from other devices and components of the distributed system 900, such as other devices having access to the communication network 984 (e.g., facility 102). For instance, in some embodiments, the electronic address 904 is utilized to receive a request from a remote device associated with a first facility 102-1 to initiate producing high-pressure steam for utilization by a second facility 102-2 using the computer system 900. However, the present disclosure is not limited thereto. In some embodiments, the electronic address 904 is utilized to receive the request from the remote device associated with the first facility 102-1 to initiate producing high-pressure steam for utilization by the first facility 102-1 using the computer system 900.

In some embodiments, the computer system 900 includes a control module 906, hereinafter “controller,” that is configured to control one or more operations conducted when producing high-pressure steam. Specifically, the controller 906 is configured to control the one or more operations conducted when producing the high-pressure steam in accordance with a plurality of heuristic instructions. As a non-limiting example, in some embodiments, the plurality of heuristic instructions include one or more proportional, integral, and derivative (PID) loop instructions and/or one or more variable frequency drive (VFD) instructions. For instance, in some embodiments, the controller 906 is in electronic communication with one or more sensors (e.g., sensor 982 of FIG. 9), in which each sensor 982 in one or more sensors 982 is configured to determine a status associated with a respective instrument 910. In some embodiments, the controller 906 is in electronic communication with the one or more sensors 982 that includes a first set of sensors 982 configured to determine one or more temperatures associated with a system (e.g., heat pump system of method 800 of FIG. 8, system 104 of any of FIGS. 1-7, etc.) (e.g., a temperature of hot water received by the system 104, a temperature of low-pressure steam produced by a flash vessel train of the system 104, a temperature of high-pressure steam produced by a compressor train of the system 104, a temperature of steam condensate source received by the system 104, a temperature of condensate produced by the system 104, a temperature loss at some or all of the system 104, etc.), a second set of sensors 982 configured to determine or more pressures associated with the system 104 (e.g., an interior pressure of the flash vessel train, a pressure ratio of the compressor train, a pressure loss at some or all of the system 104, etc.), a third set of sensors 982 configured to determine one or more flow rates (e.g., a mass flow rate of hot water received by the system 104, a mass flow rate of low-pressure steam produced by a flash vessel train of the system 104, a mass flow rate of high-pressure steam produced by a compressor train of the system 104, etc.) associated with the system 104, a fourth set of sensors 982 configured to determine one or more velocities associated with the system 104 (e.g., a velocity of hot water received by the system 104, a velocity of low-pressure steam produced by a flash vessel train 210 of the system 104, a velocity of high-pressure steam produced by a compressor train 202 of the system, a velocity of steam condensate source received by the system 104, etc.), a fifth set of sensors 982 configured to determine one or more electrical states associated with the system 104 (e.g., one or more electrical loads, one or more voltage drops across some or all of the system 104, one or more arc flashes, one or more groundings, etc.), or a combination thereof. Accordingly, by communicating electronically with the one or more sensors 982, the controller 906 allows for the computer system 900 to control a flow rate of the high-pressure steam produced by the system 104 that is received by the facility 102. However, the present disclosure is not limited thereto.

An instrument 910 is an apparatus, device, mechanism, or a combination thereof that conducts a specific function or functions in the system 104 for producing high-pressure steam, such as for producing a high-pressure steam product (e.g., high-pressure steam of method 800 of FIG. 8, high-pressure steam 140-1 or 140-2 of FIG. 1A, high-pressure steam 140 of any of FIGS. 2A-7, etc.) or a cooling water product (e.g., cooling water source 120 of any of FIGS. 1A-6, etc.) associated with the system 104. For instance, in some embodiments, each respective instrument 910 in the plurality of instruments 910 is configured to conduct a specific task 914 or tasks 914 in the system 104 for producing high-pressure steam 140. Examples of instruments 910 include, but are not limited to, a blower, a boiler (e.g., a heat recovery boiler, boiler 236 of FIG. 5A, etc.), a burner, a compressor (e.g., first compressor 204-1 of compressor train 202 of FIG. 2, etc.), a conduit (e.g., first conduit for conveying hot water received by hot water source 110 of FIG. 2, second conduit for conveying low-pressure steam 206 produced by flash vessel 212, etc.), a desuperheater (e.g., first desuperheater 232-1 of desuperheater train 230 of FIG. 5A, etc.), a drum, a heat exchanger, a pump (e.g., repressurization pump 220 of FIG. 5A, etc.), a pipe, a reservoir, a valve (e.g., valve 218-1 of FIG. 3, etc.), a vessel (e.g., flash vessel), or the like. For instance, in some embodiments, the one or more instruments 910 includes a compressor train 202 that further includes a series of at least two compressors 204 that is configured to supply the high-pressure steam 140 to an existing steam header (e.g., block 810 of FIG. 8) of the facility (e.g., facility 102-1 of FIG. 1A). However, the present disclosure is not limited thereto.

In some embodiments, each task 914 is associated with a function, step, or process in the production of high-pressure steam 140 (e.g., function, step, or process of method 800 of FIG. 8, etc.), which is performed by a set of instruments 910. As a non-limiting example, in some embodiments, one or more tasks 914 for producing the high-pressure steam 940 include receiving hot water (e.g., block 806 of FIG. 8), determining a first temperature of the hot water received from the hot water source 110, determining a saturation pressure of the hot water received from the hot water source 110, passing the hot water through the system 104 (e.g., block 808 of FIG. 8), expanding the hot water at a flash vessel (e.g., block 808 of FIG. 8), producing low-pressure steam (e.g., block 808 of FIG. 2), producing cooled water (e.g., block 808 of FIG. 8), maintaining the flash vessel at a first pressure less than a saturation pressure of the hot water (e.g., block 808 of FIG. 8), compressing the low-pressure steam (e.g., block 808 of FIG. 8), desuperheating the low-pressure steam, supplying the high-pressure steam from system 104 to an existing steam header of the facility 102 (e.g., block 810 of FIG. 8), or the like.

Moreover, each task 914 includes a set of parameters 916 used in the performance of a function by a respective instrument 910. In some embodiments, each task 914 is a logical dependency of operations that defines the function performed by the respective instrument 910. For instance, in some embodiments, the task 914 is a first operation to run a first instrument 910-1 with a first set of parameters 916 and a second task 914-2 is a second operation to run a second instrument 910-2. As a non-limiting example, in some embodiments, the parameters 916 include a temperature of hot water received from hot water source 110 by the system 104, a pressure of hot water received from hot water source 110 by the system 104, a mass flow rate of hot water received from hot water source 110 by the system 104, a temperature of low-pressure steam 206 produced by the system 104, a pressure of low-pressure steam 206 produced by the system 104, a mass flow rate of low-pressure steam 206 produced by the system 104, a temperature of high-pressure steam 140 produced by the system 104, a pressure of high-pressure steam 140 produced by the system 104, a mass flow rate of high-pressure steam 140 produced by the system 104, a temperature of cooling water received from cooling water source 120 produced by the system 104, a pressure of cooling water received from cooling water source 120 produced by the system 104, a mass flow rate of cooling water received from cooling water source 120 produced by the system 104, a temperature of steam condensate return 214 received by the system 104, a pressure of steam condensate return 214 received by the system 104, a mass flow rate of steam condensate return 214 received by the system 104, and/or the like. As a non-limiting example, in some embodiments, the computer system 900 configures one or more parameters 916 including configuring a flow rate parameter 916 associated with a respective instrument 910 (e.g., mass flow rate), a pressure parameter 916, a temperature parameter 916, a directional parameter 916, or the like in order to optimize production of the high-pressure steam 140 at the system 104. However, the present disclosure is not limited thereto.

Each of the above identified modules and applications correspond to a set of executable instructions for performing one or more functions described above and the methods described in the present disclosure (e.g., the computer-implemented methods and other information processing methods described herein, method 800 of FIG. 8, etc.). These modules (e.g., sets of instructions) need not be implemented as separate software programs, procedures or modules, and thus various subsets of these modules are, optionally, combined or otherwise re-arranged in various embodiments of the present disclosure. In some embodiments, the memory 992 optionally stores a subset of the modules and data structures identified above. Furthermore, in some embodiments, the memory 992 stores additional modules and data structures not described above.

It should be appreciated that the computer system 900 of FIG. 9 is only one example of a computer system 900, and that the computer system 900 optionally has more or fewer components than shown, optionally combines two or more components, or optionally has a different configuration or arrangement of the components. The various components shown in FIG. 9 are implemented in hardware, software, firmware, or a combination thereof, including one or more signal processing and/or application specific integrated circuits.

Additional example implementations of the heat pump system 400 are described as follows:

### Example 1: A Heat Pump System of the Present Disclosure Configured to Modularly Connect to an Existing Steam Header of a Facility

In some embodiments, a heat pump system (e.g., heat pump system 104 of any of FIGS. 1A-7, etc.) was configured to have modular characteristics with a product-and/or-facility (e.g., facility 102-1 of FIG. 1A, facility 102-2 of FIG. 1A, etc.) family approach. More particularly, in some embodiments, a baseline heat pump system 104 was configured to receive hot water at the lowest specified temperature of a family of facilities 102, generate high-pressure steam 140 at the highest specified pressure in the family of facilities 102, and provide the high-pressure steam at the maximum flow rate in family of facilities 102. In some embodiments, for a facility 102 in the family of facilities 102 with increased hot water temperatures in comparison to other facilities in the family of facilities, the baseline heat pump system 104 was modified by depopulating (e.g., removing) one or more compressors 204 at a downstream (e.g., low-pressure) portion of a compressor train 202 of the facility 102. In some embodiments, for a facility 102 in the family of facilities 102 with decreased outlet steam pressure, the baseline heat pump system 104 was modified by depopulating (e.g., removing) one or more compressors 204 at an upstream (e.g., high-pressure side) of the compressor train 202. In some embodiments, for a facility 102 in the family of facilities 102 with reduced high-pressure steam 140 flow rates, the baseline heat pump system 104 was modified by determining a first temperature of hot water received from the facility 102 and outlet pressure of the high-pressure steam received by the facility 102, and then selecting appropriate equipment sizing to support a desired flow rate of the high-pressure steam 140.

In some embodiments, one or more components of the system 104 were disposed on modular skids or containers designed for easy shipping and final installation.

In some embodiments, the baseline heat pump system 104 was configured to address the edges of the operating parameters 916, such as a minimum hot water source 110 temperature, a minimum steam condensate return 214 temperature, a maximum high-pressure steam 140 temperature, a maximum high-pressure steam 140 pressure, a maximum high-pressure steam 140 flow rate, or a combination thereof. In some embodiments, one or more portions of the compressor train 202 and/or the flash vessel train 210 is depopulated from the baseline heat pump system 104 to accommodate higher heat source temperatures and/or lower steam outlet temperature and/or pressure. For instance, in some embodiments, the baseline heat pump system 104 was configured to address minimum hot water source 110 temperature received from the facility 102 at least 60 degrees Fahrenheit (° F.) (15.6 degrees Celsius (° C.)) or at least 80° F. (26.7° C.).

In some embodiments, in accordance with a determination that the hot water source 110 is above 80° F. (26.7° C.), the baseline heat pump system 104 was modified by increasing the pressure of the flash vessel train 210 and depopulating one or more compressors 204 at a front end portion of the compressor train 202.

In some embodiments, in accordance with a determination that the high-pressure steam 140 received by the facility is less than 290 PSIg (20 Bar), the baseline heat pump system 104 was modified by depopulating one or more compressors 204 at a rear end portion of the compressor train 202.

In some embodiments, in accordance with a determination that the high-pressure steam 140 required a flow rate below 50 kilopounds (klb) per hour, one or more flash vessels 212 of the flash vessel train 210 and/or one or more compressors 204 of the compressor train 202 are substituted for a corresponding one or more flash vessels 212 and/or one or more compressors 204 configured for lower flow rates.

Since the density of steam increases as pressure increases, mass flow for a given size of a compressor 204 also increases. Accordingly, in some embodiments, the systems, methods, and apparatus of the present disclosure utilize the upper boundary of operating parameters, such as a 20 Barg output pressure of the high-pressure steam 140, and determined the minimum flow rates (e.g., after desuperheating via the desuperheater train 230) that the compressor train 202 yields such pressure at high efficiency and maximal compression ratio. In some embodiments, at the minimum flow rates, the systems, methods, and apparatus of the present disclosure determined the inlet pressure of hot water received from the hot water source 110 needed to achieve the 20 Barg output pressure of the high-pressure stream produced thereto. In some embodiments, the systems, methods, and apparatus of the present disclosure iteratively repeated this process on the remaining compressors 204 of the compressor train 202, until 35 mBara inlet pressure of the hot water received by the system 104 is reached.

In some embodiments, the baseline heat pump system 104 was modified in accordance with a unique set of parameter requirements associated with performance of the heat pump system 104 and/or one or more processes performed at a facility. For instance, in some embodiments, the unique set of parameter 916 requirements included the temperature of the hot water source 110 received by the system 104, the pressure of the high-pressure steam 140 produced by the system 104, and the mass flow rate of the high-pressure steam 140 produced by the system 104. In some embodiments, the systems, methods, and apparatus of the present disclosure configured the baseline heat pump system 104 into two or more sub-assemblies. Each sub-assembly included one or more compressors 204 of the compressor train 202 that is configured to be removed from the front end portion and/or the rear end portion of the compressor train 202. In some embodiments, each sub-assembly included one or more flash vessels 212 of the flash vessel train 210. By modifying the baseline heat pump system 104 through the sub-assemblies, the compressor train 202 was modified to change the temperature of the hot water source 110 received by the system 104, the pressure of the high-pressure steam 140 produced by the system 104. Moreover, in some embodiments, alternative sub-assemblies included smaller lower-flow compressors 204 that were substituted into the baseline heat pump system 104 to change the mass flow rate of the high-pressure steam 140 produced by the system 104 while optimizing for COP, cost, and size of the system 104.

Accordingly, by providing the heat pump system 104 in the modular configuration, the present disclosure allows for pre-engineered (e.g., pre-configured) and/or factory-produced packaged systems 104 ready to connect to a pre-existing facility 102.

Moreover, in some embodiments, this modular configuration of the heat pump system 104 allowed the cost and layout footprint of the heat pump system 104 to be optimized for a given application associated with a facility 102, while simultaneously providing standardization needed to achieve economies of scale when manufacturing the heat pump system 104. Furthermore, in some embodiments, the modular configuration of the heat pump system 104 allowed for production-level quality and reliability assurance, which was accomplished by qualifying the two or more sub-assemblies in addition to qualifying incoming components of the heat pump system 104.

Additionally, in some embodiments, the modular configuration of the heat pump system 104 allowed for factory fabrication of the heat pump system 104 in one or more skids, allowed for transportation of the heat pump system 104 from a factory to the facility 102 via standard truck-based transport, allowed for simple, non-complex on-site installation of the one or more skids at defined interface points at the facility 102, allowed for a minimized footprint area, allowed for easy removal and/or substitution of a sub-assembly, or a combination thereof.

For instance, in some embodiments, the footprint (e.g., surface area beneath the system 104) was between 2,000 square feet (ft²) and 8,000 ft², inclusive, such as 150 foot length by 50 foot width footprint of the system 104.

### Example 2: A Computer System, Method, and Non-Transitory Computer-readable Storage Medium for Configuring a Heat Pump System

In some embodiments, the present disclosure provided computer systems, methods, and a non-transitory computer-readable storage mediums for configuring a heat pump system 104.

In some embodiments, the computer systems, methods, and a non-transitory computer-readable storage mediums of the present disclosure allow for selection and configuration of one or more sub-assemblies of the heat pump system 104 in order to optimally satisfy a given set of parameter 916 requirements associated with a facility 102.

In some embodiments, the computer systems, methods, and a non-transitory computer-readable storage mediums of the present disclosure provide a lookup table. In some embodiments, the lookup table was utilized to match one or more ranges of various parameter requires, such as a first temperature of hot water received from the facility 102 and/or an outlet pressure of the high-pressure steam received by the facility 102 from the system 104 with specific combinations of two or more sub-assembles that were configured to operating collectively.

In some embodiments, the computer systems, methods, and a non-transitory computer-readable storage mediums of the present disclosure evaluated the performance of the heat pump system 104 based on the given set of parameter 916 requirements associated with the facility 102. For instance, in some embodiments, the computer systems, methods, and a non-transitory computer-readable storage mediums of the present disclosure determined the given set of parameter 916 requirements in the lookup table, then used the lookup table to select two or more sub-assemblies. In some embodiments, the computer systems, methods, and a non-transitory computer-readable storage mediums of the present disclosure evaluated the performance of the heat pump system 104 that included the two or more sub-assemblies selected through the lookup table. In some embodiments, the computer systems, methods, and a non-transitory computer-readable storage mediums of the present disclosure display a report that includes a complete, pre-qualified configuration of the heat pump system and the two or more sub-assembles that is ready for fabrication, and a performance specification for that configuration.

### Example 3: A Heat Pump System

Referring to FIG. 5A, in some embodiments, the present disclosure provided a system 104 for producing high-pressure steam.

In some embodiments, the system 104 included a compressor train 202. The compressor train 202 includes a series of at least two compressors 204. In some embodiments, the series of at least two compressors 204 included at least four compressors 204. Moreover, the compressor train 202 included an inlet 216 of the compressor train 202. Furthermore, the compressor train 202 included an outlet 208 of the compressor train 202 that is configured to provide high-pressure steam 140 to a facility 102. In some embodiments, the series of at least two compressors 204 is disposed interposing between the inlet of the compressor train 202 and the outlet of the compressor train 202.

In some embodiments, the system further included a flash vessel train 210. The flash vessel train 210 included a series of at least two flash vessels 212, in which the series of at least two flash vessels further included a terminal flash vessel 212 at one end of the flash vessel train 210. In some embodiments, the series of at least two flash vessels 212 included at least four flash vessels 212. Moreover, a vapor outlet 226 of the terminal flash vessel 212 is fluidly coupled to the inlet 216 of the compressor train 202. Additionally, the system 104 included vapor outlets 226 of a remainder of the series of at least two flash vessels 212 that are fluidly coupled between compressors 204 of the series of at least two compressors 204.

In some embodiments, the system 104 was configured to receive hot water received from hot water source 110 at a temperature of 120° F. (48.9° C.). In some embodiments, the system 104 was configured to receive steam condensate return 214 at a temperature of 200° F. (93.3° C.).

In some embodiments, each flash vessel 212 in the series of at least two flash vessels 212 of the flash vessel train 210 was configured to be maintained at an internal pressure less than a saturation pressure of hot water input into the respective flash vessel 212, and is configured to expand the hot water to produce low-pressure steam. For instance, in some embodiments, the terminal flash vessel 212-1 was configured to be maintained at an internal pressure less than the saturation pressure of hot water at 120° F. (48.9° C.) (e.g., the saturation pressure of water at 120° F. is 116.9 mBar, which yields an internal pressure below 116.8 mbar(a) for the respective flash vessel), a second flash vessel 212-2 was configured to be maintained at an internal pressure less than the saturation pressure of hot water at 140° F. (60° C.), a third flash vessel 212-3 was configured to be maintained at an internal pressure less than the saturation pressure of hot water at 160° F. (71.1° C.), and a fourth flash vessel 212-4 was configured to be maintained at an internal pressure less than the saturation pressure of hot water at 180° F. (82.2° C.). Accordingly, in some embodiments, the internal pressure of a first terminal flash vessel (e.g., flash vessel 212-1 of any of FIGS. 2A-5B, etc.) was configured to be maintained at a pressure less than less than the saturation pressure of the hot water received from hot water source 110 received by the system 104. Moreover, in some embodiments, the internal pressure of a second terminal flash vessel (e.g., flash vessel 212-2 of any of FIGS. 2A-5B, etc.) was configured to be maintained at a pressure less than less than the saturation pressure of the steam condensate return 214 received by the system 104.

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that includes a computer program mechanism embedded in a non-transitory computer-readable storage medium. For instance, the computer program product could contain the program modules shown in any combination of the Figures. These program modules can be stored on a CD-ROM, DVD, magnetic disk storage product, USB key, or any other non-transitory computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed is:

1. A system for producing high-pressure steam, the system comprising:
a compressor train comprising:
a series of at least two compressors;
an inlet of the compressor train; and
an outlet of the compressor train configured to provide high-pressure steam to a facility; and
a flash vessel train comprising:
a series of at least two flash vessels comprising a terminal flash vessel at one end of the flash vessel train, wherein a vapor outlet of the terminal flash vessel is fluidly coupled to the inlet of the compressor train;
an inlet of the flash vessel train configured to receive hot water received from the facility or a different facility;
the remainder of the series of at least two flash vessels each comprises a liquid outlet fluidly coupled to an inlet of another one of the series of at least two flash vessels;
the terminal flash vessel comprises a liquid outlet fluidly coupled to an outlet of the system;
vapor outlets of a remainder of the series of at least two flash vessels that are fluidly coupled between compressors of the series of at least two compressors; and
each flash vessel in the series of at least two flash vessels is configured to be maintained at an internal pressure less than a saturation pressure of the hot water input into the respective flash vessel and is configured to expand the hot water to produce low-pressure steam.

2. The system of claim 1, wherein the system further comprises a controller configured to maintain a temperature range of the flash vessel train in a range of a first temperature of the high-pressure steam and a second temperature of the outlet of the system.

3. The system of claim 2, wherein the series of at least two compressors comprises a centrifugal compressor, and wherein the controller is configured to modify a rotational velocity of a respective compressor in the compressor train, thereby maintaining a pressure of the outlet of the compressor train and to maintain the centrifugal compressor from stonewalling and/or surging.

4. The system of claim 1, wherein the terminal flash vessel further comprises:
an inlet configured to receive hot water received from the facility or a different facility, and
a liquid outlet fluidly coupled to a repressurization pump that is coupled to an outlet of the system, wherein the outlet of the system is fluidically coupled to a heat exchange mechanism associated with the hot water received from the facility or the different facility.

5. The system of claim 1, wherein a flash vessel in the flash vessel train comprises a continuous blowdown configured to remove a contaminant accommodated by the flash vessel.

6. The system of claim 1, wherein a flash vessel in the flash vessel train comprises a second liquid outlet fluidly configured to selectively remove fluid from a corresponding flash vessel.

7. The system of claim 6, further comprising a controller in electronic communication with the second liquid outlet, wherein the controller is configured to control selective removal of fluid from the flash vessel.

8. The system of claim 1, further comprising a desuperheater train comprising at least one desuperheater, wherein each desuperheater in the desuperheater train comprises an outlet configured to inject water received from the facility, a different facility, or the system into the compressor train, and wherein at least one desuperheater of the desuperheater train is configured to control a flow rate of fluid through the desuperheater.

9. The system of claim 8, wherein, in accordance with a determination that a temperature and/or a pressure associated with the compressor train satisfies a first pressure and/or a first temperature, the controller is configured to modify a flow rate of fluid through the desuperheater.

10. The system of claim 1, wherein the system comprises a coefficient of performance greater than 65 percent of a corresponding Carnot efficiency.

11. The system of claim 1, further comprising a boiler disposed interposing between and fluidly coupled to an output of a terminal compressor in the compressor train and the outlet of the compressor train.

12. The system of claim 1, further comprising a steam accumulator disposed interposing between and fluidly coupled an output of a terminal compressor in the compressor train and the outlet of the compressor train.

13. The system of claim 1, wherein the compressor train comprises between two and twenty compressors, inclusive.

14. The system of claim 1, wherein
the compressor train comprises m compressors; and
m is an integer greater than two and selected in accordance with a temperature of the high-pressure steam and a temperature of hot water received from the facility or a different facility.

15. The system of claim 1, wherein each compressor in the compressor train and each flash vessel in the flash vessel train share a one-to-one relationship.

16. The system of claim 1, wherein the compressor train comprises a first compressor comprising a first size and a second compressor comprising a second size less than the first size, and wherein the first compressor is coupled upstream of the second compressor in the compressor train.

17. The system of claim 16, wherein the compressor train comprises a third compressor interposing between and fluidically coupled to the first compressor and the second compressor, wherein the third compressor comprises either the first size or the second size.

18. The system of claim 1, wherein each compressor in the compressor train comprises a compression ratio of less than 2.5.

19. The system of claim 1, wherein the outlet of the compressor train is configured to provide the high-pressure steam at a pressure between 0 pounds per square inch gauge (PSIg) (0 Barg) and 315 PSIg (21.7 Barg), inclusive.

20. The system of claim 1, further comprising a water loop comprising a downstream portion configured to receive the hot water from the same or a different facility, and an upstream portion configured to supply cooling water to the same or the different facility, wherein the water loop is heated by the same or the different facility.
